(19) United States
(12) Patent Application Publication
(10) Pub. No.: US 2023/0412766 A1
(43) Pub. Date: Dec. 21, 2023

(54) INFORMATION PROCESSING SYSTEM, INFORMATION PROCESSING METHOD, AND COMPUTER PROGRAM

(71) Applicant: GREE, INC., Tokyo (JP)

(72) Inventor: Daiki HAYATA, Tokyo (JP)

(73) Assignee: GREE, INC., Tokyo (JP)

(21) Appl. No.: 18/211,001

(22) Filed: Jun. 16, 2023

(30) Foreign Application Priority Data
Jun. 17, 2022 (JP) 2022-097871

(51) Int. Cl. H04N 7/15; G06T 13/40; G06V 40/20

(52) U.S. Cl. CPC H04N 7/157; G06T 13/40; H04N 7/152; G06V 40/20

(57) ABSTRACT

An information processing system includes one or more processors programmed to receive information for generating a video, including information related to movement of a user, information related to sound, and information related to a character object, that is sent from a user terminal of the user; execute a video chat between a plurality of users using character objects, based on the received information for generating the video; specify a state of the user terminal; and change a display mode of the character object corresponding to the user terminal according to the specified state of the user terminal.

This application claims the benefit of priority from Japanese Patent Application No. 2022-097871 filed Jun. 17, 2022, the entire contents of the prior application being incorporated herein by reference.

### TECHNICAL FIELD

This disclosure relates to an information processing system, an information processing method, and a computer program.

### BACKGROUND TECHNOLOGY

An information processing system is known that generates an animation of a character object based on movement of an actor and distributes a video including the animation of the character object.

Also, technology has been developed for executing video chats with users via a virtual space.

### SUMMARY

### Problems to be Solved

In a technical field related to such video distribution and video chat, activation of communication between participating users is one of the important problems.

An object of this disclosure is to provide technical improvements that solve or alleviate at least some of the problems of the conventional technology described above. One of the more specific objects of this disclosure is to provide an information processing system, an information processing method, and a computer program that activate communication between users.

### Means of Solving Problems

An information processing system of this disclosure is provided with:
one or more computer processors, wherein:
the one or more computer processors comprise:
   a receiver that can receive information for generating a video, including information related to movement of a user, information related to sound, and information related to a character object, that is sent from a user terminal of a user;
   an executing portion that executes a video chat between a plurality of users using character objects, based on the information for generating the video that is received by the receiver;
   a specifying portion that specifies a state of the user terminal; and
   a controller that changes a display mode of the character object corresponding to the user terminal according to the state of the user terminal specified by the specifying portion.

When the receiver has not received the information related to the movement of the user from the user terminal, or when the information related to the movement of the user received by the receiver satisfies a first condition, the specifying portion can specify that the user terminal is in a first state.

The first condition is that the receiver can continue to receive information related to a same movement for a predetermined period of time, or cannot receive, for a predetermined period of time, information related to an amount of change in movement that is sent only when the movement changes.

When the specifying portion specifies that the user terminal is in the first state, as a change in the display mode of the character object, the controller can attach a first specific object to the character object and/or apply a first specific movement to the character object.

The first specific object can be an object to indicate that the character object is not looking at a screen of the video chat; and the first specific movement can be a movement to indicate that the character object is not looking at the screen of the video chat.

When the receiver has not received the information related to the sound from the user terminal, or when the information related to the sound received by the receiver satisfies a second condition, the specifying portion can specify that the user terminal is in a second state.

When the specifying portion specifies that the user terminal is in the second state, as a change in the display mode of the character object, the controller can attach a second specific object to the character object and/or apply a second specific movement to the character object.

The second specific object can be an object to indicate that the character object is not speaking; and the second specific movement can be a movement to indicate that the character object is not speaking.

When the receiver receives information indicating that a specific application is running or being displayed at the user terminal, the specifying portion can specify that the user terminal is in a third state.

When the receiver receives information indicating that a music playback application is running at the user terminal, the specifying portion can specify that the user terminal is in the third state.

When the specifying portion specifies that the user terminal is in the third state, as a change in the display mode of the character object, the controller can attach a third specific object to the character object and/or apply a third specific movement to the character object.

The third specific object can be an object to indicate that the character object is listening to music; and the third specific movement can be a movement to indicate that the character object is listening to music.

When a volume of a sound other than speaking by the user included in the information related to the sound received by the receiver is greater than or equal to a first value, the specifying portion can specify that the user terminal is in a fourth state.

When the specifying portion specifies that the user terminal is in the fourth state, as a change in the display mode of the character object, the controller can attach a fourth specific object to the character object and/or apply a fourth specific movement to the character object.

The fourth specific object can be an object to indicate that the character object feels that sound of the video chat is difficult to hear; and

the fourth specific movement can be a movement to indicate that the character object feels that the sound of the video chat is difficult to hear.

When the specifying portion specifies that the user terminal is in the fourth state, the controller can generate the video without including information related to the sound when the volume of the other sound is greater than or equal to a second value.

When the receiver has not received information related to the movement of the user from the user terminal, but has received information related to the sound, the identifying portion can identify that the user terminal is in a fifth state.

When the specifying portion specifies that the user terminal is in the fifth state, as a change in the display mode of the character object, the controller can apply a fifth movement to the character object.

The fifth movement can move a mouth of the character object according to the information related to the sound.

The receiver can further receive position information of the user terminal sent from the user terminal; and

the specifying portion can specify that the user terminal is in a sixth state when the position information satisfies a predetermined condition.

When the specifying portion specifies that the user terminal is in the sixth state, as a change in the display mode of the character object, according to a movement speed based on the position information, the controller can attach a sixth specific object to the character object and/or apply a sixth specific movement to the character object.

The sixth specific object can be an object to indicate that the character object is moving; and

the sixth specific movement can be a movement to indicate that the character object is moving.

The receiver can further receive instruction information sent from the user terminal; and

the controller can change a display mode of the character object according to the instruction.

As a change in the display mode of the character object, the controller can attach a seventh specific object to the character object and/or apply a seventh specific movement to the character object.

The seventh specific object can be an object on which predetermined text is displayed; and

the seventh specific movement can be a movement of moving at least part of the character object at predetermined intervals.

The specifying portion can specify that the user terminal is in an eighth state when a volume of speaking by the user included in the information related to the sound received by the receiver satisfies a predetermined condition.

When the specifying portion specifies that the user terminal is in the eighth state, according to the volume of speaking, the controller can further attach an eighth specific object t, the character object and/or cause an eighth specific object to be displayed in the video.

An information processing method of this disclosure causes one or more computer processors to execute the following:
a receiving step that can receive information for generating a video, including information related to movement of a user, information related to sound, and information related to a character object, that is sent from a user terminal of the user;
an executing step that executes a video chat between a plurality of users using character objects based on the information for generating the video that is received in the receiving step;
a specifying step that specifies a state of the user terminal; and
a control step that changes a display mode of the character object corresponding to the user terminal according to a state of the information processing device specified in the specifying step.

An information processing method of this disclosure causes one or more computer processors provided in an information processing device to execute the following:
a sending step that can send, to a server device, information for generating a video related to a user, including information related to movement of the user, information related to sound, and information related to a character object;
a receiving step that can receive, from the server device, information for generating a video related to another user, including information related to movement of the other user, information related to sound, and information related to a character object;
an executing step that executes a video chat between a plurality of users using character objects, based on the information for generating the video related to the user and information for generating the video related to the other user;
a specifying step that specifies a state of the information processing device; and
a control step that changes a display mode of the character object corresponding to the user terminal according to a state of the information processing device specified in the specifying step.

A computer program of this disclosure causes one or more computer processors provided in an information processing device to realize the following:
a sending function that can send, to a server device, information for generating a video related to a user, including information related to movement of the user, information related to sound, and information related a character object;
a receiving function that can receive, from the server device, information for generating a video related to another user, including information related to movement of the other user, information related to sound, and information related to a character object;
an executing function that executes a video chat between a plurality of users using character objects, based on the information for generating the video related to the user and information for generating the video related to the other user;
a specifying function that specifies a state of the information processing device; and
a control function that changes a display mode of the character object corresponding to the user terminal according to a state of the user terminal specified in the specifying function,

### [Effects]

According to this disclosure, technical improvements that solve or alleviate at least some of the problems of the conventional technology described above can be provided. Specifically, according to this disclosure, it is possible to provide technology that activates communication between users.

### BRIEF DESCRIPTION OF DRAWINGS

FIG. 1 is a system configuration diagram showing an example of an information processing system in this disclosure.

FIG. 2 is a system configuration diagram showing an example of an information processing system in this disclosure.

FIG. 3 is a system configuration diagram showing an example of an information processing system in this disclosure.

FIG. 4 is a configuration diagram showing an example of a hardware configuration of a server device, a distributing user terminal, and a viewing user terminal in this disclosure.

FIG. 5 is a conceptual diagram showing an image of a screen displayed on a user terminal.

FIG. 6 is a conceptual diagram showing an image of a screen displayed on a user terminal.

FIG. 7 is a conceptual diagram showing an image of a screen displayed on a user terminal.

FIG. 8 is a conceptual diagram showing an image of a screen displayed on a user terminal.

FIG. 9 is a conceptual diagram showing an image of a screen displayed on a user terminal.

FIG. 10 is a conceptual diagram showing an image of a screen displayed on a user terminal.

FIG. 11 is a conceptual diagram showing an image of a screen displayed on a user terminal.

FIG. 12 is a conceptual diagram showing an image of a screen displayed on a user terminal.

FIG. 13 is a conceptual diagram showing an image of a screen displayed on a user terminal.

FIG. 14 is a conceptual diagram showing an image of a screen displayed on a user terminal.

FIG. 15 is a conceptual diagram showing an image of a screen displayed on a user terminal.

FIG. 16 is a conceptual diagram showing an image of a screen displayed on a user terminal.

FIG. 17 is a conceptual diagram showing an image of a screen displayed on a user terminal.

FIG. 18 is a conceptual diagram showing an image of a screen displayed on a user terminal.

FIG. 19 is a conceptual diagram showing an image of a screen displayed on a user terminal.

FIG. 20 is a conceptual diagram showing an image of a screen displayed on a user terminal.

FIG. 21 is a conceptual diagram showing an image of a screen displayed on a user terminal.

FIG. 22 is a conceptual diagram showing an image of a screen displayed on a user terminal.

FIG. 23 is a conceptual diagram showing an image of a screen displayed on a user terminal.

FIG. 24 is a configuration diagram showing an example of a functional configuration of a server device in this disclosure.

FIG. 25 is a conceptual diagram showing an image of a screen displayed on a user terminal.

FIG. 26 is a conceptual diagram showing an image of a screen displayed on a user terminal.

FIG. 27 is a conceptual diagram showing an image of a screen displayed on a user terminal.

FIG. 28 is a conceptual diagram showing an image of an object or movement to be applied to a character object.

FIG. 29 is a conceptual diagram showing an image of an object or movement to be applied to a character object.

FIG. 30 is a conceptual diagram showing an image of an object or movement to be applied to a character object.

FIG. 31 is a conceptual diagram showing an image of an object or movement to be applied to a character object.

FIG. 32 is a conceptual diagram showing an image of an object or movement to be applied to a character object.

FIG. 33 a flowchart showing an example of a flow of an information processing method in this disclosure.

FIG. 34 is a circuit configuration diagram showing an example of a circuit configuration for realizing a computer program in this disclosure

FIG. 35 is a configuration diagram showing an example of a functional configuration of a user terminal in this disclosure.

FIG. 36 is a flowchart showing an example of a flow of an information processing method in a user terminal in this disclosure.

FIG. 37 is a circuit configuration diagram showing an example of a circuit configuration for realizing a computer program executed on a user terminal in this disclosure.

### MODES TO IMPLEMENT EMBODIMENTS

First, an overview of an information processing system according to an embodiment of this disclosure will be described with reference to the drawings.

The information processing system in this disclosure is an information processing system including one or more client devices and a server device, and includes one or more computer processors.

A video displayed on each client device is described as including an animation of a 3D or 2D character object generated based on movement of a distributing user, but the description is not limited to this, and the video may include an animation of a character object generated in response to an operation by the distributing user, or may include an image of the distributing user himself/herself. Further, the video may also include only the voice of the distributing user, without displaying a character object or the distributing user.

Here, a distributing user means a user who sends information related to video and/or sound. For example, a distributing user can be a user who organizes or hosts a single video distribution, a collaborative distribution in which multiple people can participate, a video or voice chat that multiple people can participate in and/or view, or an event (for example, a party) in a virtual space that multiple people can participate in and/or view, that is, a user who mainly performs these functions. Therefore, the distributing user in this disclosure can also be called a host user, a sponsor user, a hosting user, or the like.

Meanwhile, a viewing user means a user who receives information related to video and/or sound. However, the viewing user can be a user who not only receives the above information, but can also react to it. For example, a viewing user can be a user who views a video distribution; a collaborative distribution, or a user who participates in and/or views a video or voice chat, or an event. Therefore, the viewing user in this disclosure can also be referred to as a guest user, a participating user, a listener, a spectator user, a cheering user, or the like.

The information processing system in an embodiment of this disclosure can be used to provide the next Internet space (metaverse), which is a digital world in which many people can participate simultaneously and freely engage in activities such as interaction, work, and play via character objects (avatars) at a level close to that of the real world. Social activities can be carried out transcending the gap between reality and virtuality.

In such a space, user avatars can freely walk around the world and communicate with each other.

Additionally, one avatar (character object) among the plurality of avatars in the virtual space may be configured to be able to distribute a video as a character object of a distributing user. That is, one-to-many video distribution can be performed in a many-to-many metaverse virtual space.

In such a space, there may be no particular distinction between a distributing user and a viewing user.

The space displayed in the video may be a virtual space, a real space, or an augmented reality space that is a combination thereof. The video may be a karaoke video or a live game video that plays at least a predetermined image and the voice of the distributing user, or it may be a superimposed display of a character object, or a real image of the distributing user, on these images.

Further, when the distributing user is included in a real space, a character object generated based on movement of the distributing user may be superimposed and displayed on the actual image of the distributing user. Further, an animation such as a gift object may be superimposed and displayed on a captured image of the real space.

### <System Configuration>

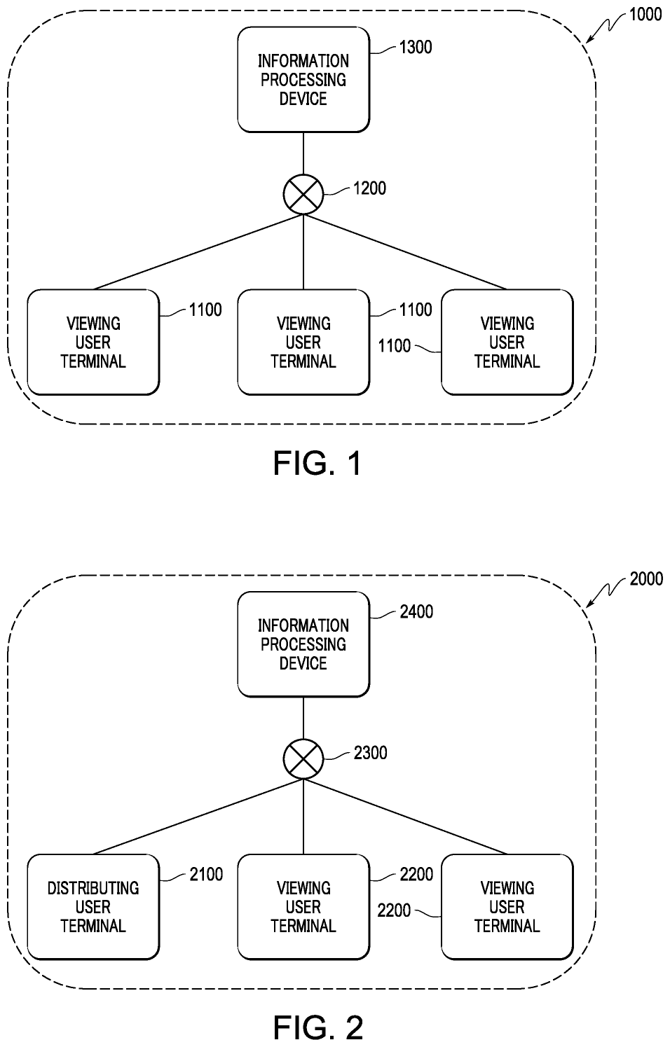

As shown as an example in FIG. 1, an information processing system 1000 according td this disclosure includes (i) one or more viewing user terminals 1100, and (ii) an information processing; device (support computer) 1300 arranged in a video distribution studio or the like, which is connected to these viewing user terminals 1100 via a network 1200.

Further, the information processing device 1300 may be connected to a predetermined server device via the Internet, and part or all of the processing to be performed by the information processing device 1300 may be performed by the server device. The server device may be an information processing device 2400 shown in FIG. 2.

In this specification, distribution by the information processing system 1000 is referred to as studio distribution.

In studio distribution, movement of an entire body of a distributing user (actor) will be reflected in a character in real time by shooting markers attached to the distributing user with a camera(s) installed in the studio and using known motion capture technology.

Additionally, the information processing system 1000 can also work in cooperation with another information processing system 2000, shown in FIG. 2 as an example. The information processing system 2000 shown in FIG. 2 can include (i) a distributing user terminal 2100, (ii) one or more viewing user terminals 2200, and (iii) and an information processing device (server device) 2400 that is connected to the distributing user terminal 2100 and the viewing user terminals 2200 via a network 2300.

In the above example, the distributing user terminal 2100 can be an information processing terminal such as a smartphone. In this specification, distribution by such information processing system 2000 is referred to as mobile distribution.

In mobile distribution, the movement of the distributing user's face is captured by a camera provided in the distributing user terminal 2100 and reflected on the character's face in real time using known face tracking technology.

There is no particular distinction between a distributing user and a viewing user in mobile distribution. A viewing user can perform mobile distribution at any time, and a distributing user can be a viewing user when viewing a video of another distributing user.

The video generated by the information processing system 1000 and the information processing system 2000 can be distributed to a viewing user from one video distribution platform, as an example.

Furthermore, in any distribution, the process of generating animation by reflecting motion on a character, the process of displaying a gift described below, and the like may be shared by a distributing user terminal, a viewing user terminal, an information processing device and other devices.

That is, “distribution” here refers to sending information to make the video available for viewing at the viewing user terminal. Video rendering is performed at the information processing devices 1300, 2400 side or at the distributing user terminal 2100 and viewing user terminal 1100 and 2200 side.

Specifically, face motion data and sound data of the distributing user is sent from the distributing user terminal or information processing device to a terminal or device that generates (renders) an animation of a character object. Further, body motion may be sent in addition to the face motion.

In this disclosure, the process of generating an animation will be described as being performed by each of the distributing user terminal and the viewing user terminal, but this disclosure is not limited to this.

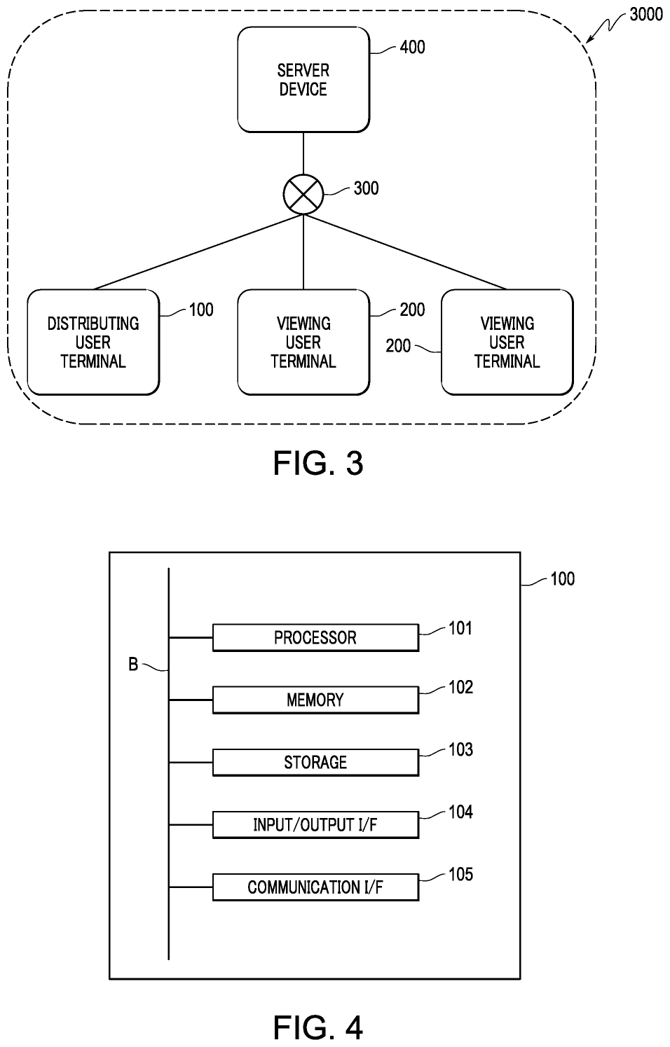

The information processing system in this disclosure can be applied to any of the examples shown in FIGS. 1 and 2. Further, an information processing system 3000 in an embodiment of this disclosure is described as being provide with a distributing user terminal 100, viewing user terminals 200, and a server device 400 that can be connected to these distributing user terminal 100 and viewing user terminals 200 via a network 300, as shown in FIG. 3.

The distributing user terminal 100 and the viewing user terminals 200 are interconnected with the server device 400 via, for example, a base station, a mobile communication network, a gateway, and the Internet. Communication is performed between the distributing user terminal 100 and the viewing user terminals 200 and the server device 400 based on a communication protocol such as the Hypertext Transfer Protocol (HTTP). Additionally, between the distributing user terminal 100 and the viewing user terminals 200 and the server device 400, communication may be performed based on WebSocket, which initially establishes a connection via HTTP communication and then performs bidirectional communication at a lower cost (less communication load and processing load) than HTTP communication. The communication method between the distributing user terminal 100 and the viewing user terminals 200 and the server device 400 is not limited to the method described above, and any communication method technology may be used as long as it can realize this embodiment.

The distributing user terminal 100 functions as at least the information processing device 1300 or distributing user terminal 2100 described above. The viewing user terminals 200 function as at least one or more viewing user terminals 1100, 2200 described above. The server device 400 functions as at least the server device or information processing device 2400 described above.

In this disclosure, the distributing user terminal 100 and the viewing user terminals 200 may each be a smartphone (multi-functional phone terminal), a tablet terminal, a personal computer, a console game machine, a head-mounted display (HMD), a wearable computer such as a spectacle-type wearable terminal (AR glasses or the like), or an information processing device other than these devices that can reproduce a video. Further, these terminals may be stand-alone devices that operate independently, or may be constituted by a plurality of devices that are connected to each other so as to be able to send and receive various data.

### <Hardware Configuration>

Here, a hardware configuration of the distributing user terminal 100 will be described using FIG. 4. The distributing user terminal 100 includes a processor 101, a memory 102, a storage 103, an input/output interface (input/output I/F) 104, and a communication interface (communication I/F) 105. Each component is connected to each other via a bus B.

The distributing user terminal 100 can realize the functions and methods described in this embodiment by the processor 101, the memory 102, the storage 103, the input/output I/F 104, and the communication I/F 105 working together.

The processor 101 executes a function and/or a method realized by a code or a command included in a program stored in the storage 103. The processor 101 may realize each process disclosed in each embodiment by a logic circuit (hardware) or a dedicated circuit formed in an integrated circuit (IC (Integrated Circuit) chip, an LSI (Large Scale Integration)) or the like, including, for example, a CPU (Central Processing Unit), an MPU (Micro Processing Unit), a GPU (Graphics Processing Unit), a microprocessor, a processor core, a multiprocessor, an ASIC (Application-Specific Integrated Circuit), an FPGA (Field Programmable Gate Array), or the like. These circuits may be realized by one or more integrated circuits. A plurality of processes shown in each embodiment may be realized by a single integrated circuit. Furthermore, LSI may also be referred to as VLSI, Super LSI, Ultra LSI, or the like, depending on difference in the degree of integration.

The memory 102 temporarily stores a program loaded from the storage 103 and provides a work area to the processor 101. Various data generated while the processor 101 is executing the program are also temporarily stored in the memory 102. The memory 102 includes, for example, a RAM (Random Access Memory), a ROM (Read Only Memory), and the like.

The storage 103 stores the program. The storage 103 includes, for example, an HDD (Hart Disk Drive), an SSD (Solid State Drive), a flash memory, or the like.

The communication I/F 105 is implemented as hardware such as a network adapter, software for communication, or a combination thereof, and is used to send and receive various types of data via the network 300. This communication may be executed by either by wire or wirelessly, and any communication protocol may be used as long as mutual communication can be executed. The communication IT 105 executes communication with another information processing device via the network 300. The communication I/F 105 sends various data to other information processing devices according to instructions from the processor 101. The communication I/F 105 also receives various data sent from other information processing devices and transmits them to the processor 101.

The input/output I/F 104 includes an input device for inputting various operations to the distributing user terminal 100 and an output device for outputting processing results processed by the distributing user terminal 100. The input/output I& 104 may be such that the input device and the output device are integrated, or may be separated into the input device and the output device.

The input device is realized by any one of all types of devices that can receive an input from a user and transmit information related to the input to the processor 101, or a combination thereof. The input device includes, for example, (i) a hardware key, such as a touch panel, a touch display, or a keyboard, (ii) a pointing device, such as a mouse, (iii) a camera (operation input via an image), and (iv) a microphone (operation input by sound).

The input device may include a sensor portion. The sensor portion is one or more sensors that detect (i) face motion, which indicates changes in the user's facial expression, and (ii) body motion, which indicates changes in the relative position of the user's body with respect to the sensor portion. Face motion includes movements such as blinking of the eyes, opening and closing of the mouth, and the like. A known device may be used as the sensor portion. An example of a sensor portion includes (i) a ToF sensor that measures and detects the time of flight (Time of Flight) until light irradiated toward the user is reflected by the user's face and returns, or the like, (ii) a camera that captures the user's face, and (iii) an image processor that image-processes the data captured by the camera. The sensor portion may also include an RGB camera for capturing visible light and a near-infrared camera for capturing near-infrared light. The RGB camera and near-infrared camera may use, for example, “True Depth” of the “iphone X (registered trademark),” “LIDER” of the “iPad Pro (registered trademark),” or other ToF sensors in smartphones. This camera specifically projects tens of thousands of invisible dots onto the user's face and the like. Then, accurate face data is captured by detecting and analyzing the reflected light of the dot pattern to form a depth map of the face and capturing infrared images of the face and the like. An arithmetic processor of the sensor portion generates various types of information based on the depth map and infrared images, and compares this information with registered reference data to calculate the depth (distance between each point and the near-infrared camera) and non-depth positional deviations for each point on the face.

Further, the sensor portion may have a function of tracking not only the user's face, but also the hand(s) (hand tracking). The sensor portion may further include a sensor other than the above-mentioned sensors such as an acceleration sensor and a gyro sensor. The sensor portion may have a spatial mapping function of (i) recognizing an object in the real space in which the user exists based on the detection results of the above ToF sensor or other known sensor, and (ii) mapping the recognized object to a spatial map. Hereinafter, when the face motion detection data and the body motion detection data are described with no particular distinction, they are simply referred to as “tracking data.” The image processor of the sensor portion may be provided with a controller that can be provided in the information processing system.

As an operation portion as an input device, a device corresponding to the type of the user terminal can be used. An example of the operation portion is a touch panel integrated with a display, an operation button provided on a housing of a user terminal, a keyboard, a mouse, a controller operated by a user, and the like. The controller may incorporate various known sensors such as an inertial measurement sensor (IMU: Inertial Measurement Unit) such as an acceleration sensor and a gyro. Furthermore, another example of the operation portion may be a tracking device that specifies the movement of the user's hand, the movement of the eyes, the movement of the head, the direction of the line of sight, and the like. In this embodiment, for example, based on the user's hand movements, the user's instructions are determined and various operations are performed such as starting or ending the video distribution, evaluating messages and videos, and requesting the display of predetermined objects (for example, the gift described below), and the like. If the sensor portion also has an input interface function such as a hand tracking function, the operation portion can be omitted.

The output device outputs the processing result processed by the processor 101. The output device includes, for example, a touch panel, a speaker, and the like.

Further, the viewing user terminals 200 and the server device 400 in this disclosure may also be configured with the same hardware configuration as in FIG. 4, unless otherwise noted.

Next, various functions that can be executed on a user terminal drat has started the application realized by the information processing system according to the embodiment of this disclosure, and the transition of the displayed screen, will be explained with reference to the drawings.

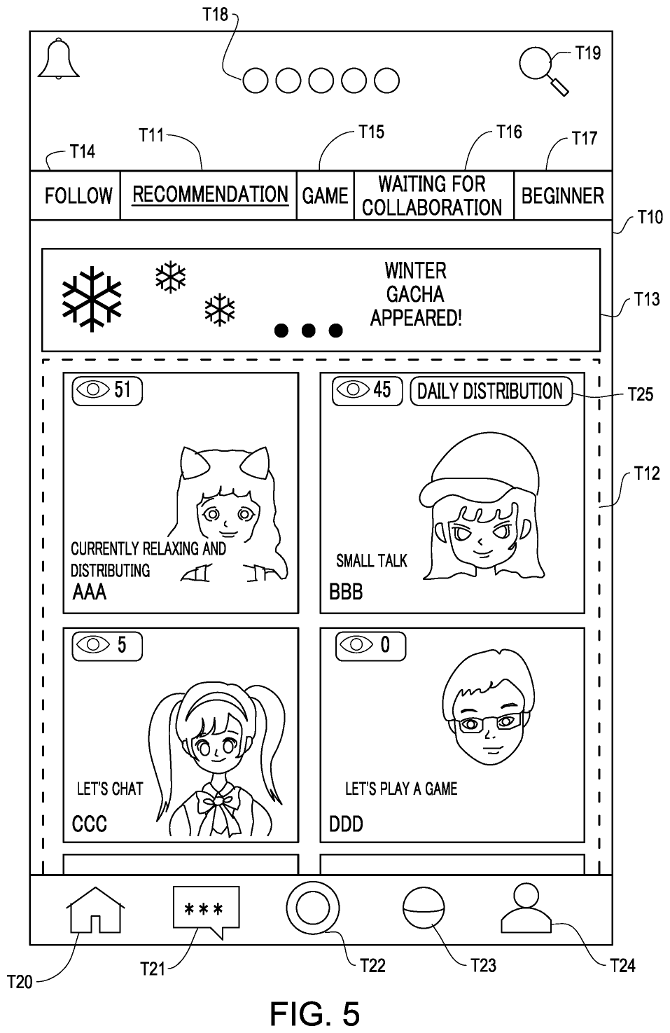

FIG. 5 shows a top screen T10 displayed on a user terminal when a video distribution/viewing application is started.

As shown in FIG. 5, by selecting one distribution channel (a distribution slot, a distribution program, a distribution video, or the like) from the thumbnail images of one or more recommended distribution channels T12 listed in a recommendation tab T11 on the top screen T10, the user can view a video played on the one distribution channel.

Alternatively, the user can view a video played on a specific distribution channel by accessing a fixed link of the specific distribution channel. Such a fixed link can be obtained by a notification from a distributing user who is being followed, a notification of a share sent from another user, or the like.

In this way, the user who views the video is the viewing user, and the terminal for viewing the video is the second user terminal 200.

Further, as shown in FIG. 5, a display field T13 for notification of a campaign, an event, or the like may be displayed on the top screen T10. The display field T13 of this notification can be switched to another notification by a slide operation.

Additionally, from the top screen T10, a follow tab T14, a game tab T15 for displaying a game category, an awaiting collaboration tab T16 for displaying a distribution channel that is awaiting collaboration, and a beginner tab T17 for displaying a beginner's distribution channel are displayed. By selecting these (by switching the tabs), the top screen T10 transitions to respective different screens.

A service name display T18 and a search button T19 in an upper frame of the top screen T10 may be fixedly displayed on a transition destination screen.

Similarly, a home button T20, a message button T21, a distribution preparation button T22, a gacha button T23, and a profile button T24 in a lower frame of the top screen T10 may be fixedly displayed on the transition destination screen.

A user who selects displayed thumbnail images T12 on the top screen T10 or the like shown in FIG. 5 becomes a viewing user who views the video as described above, and a user who selects the distribution preparation button T22 can become a distributing user who distributes a video.

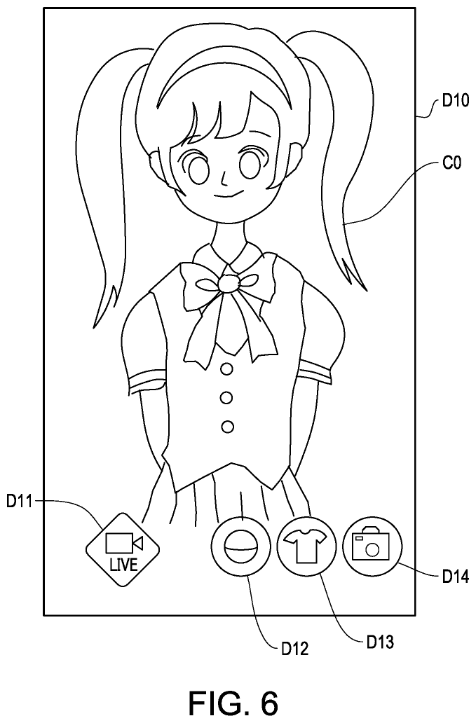

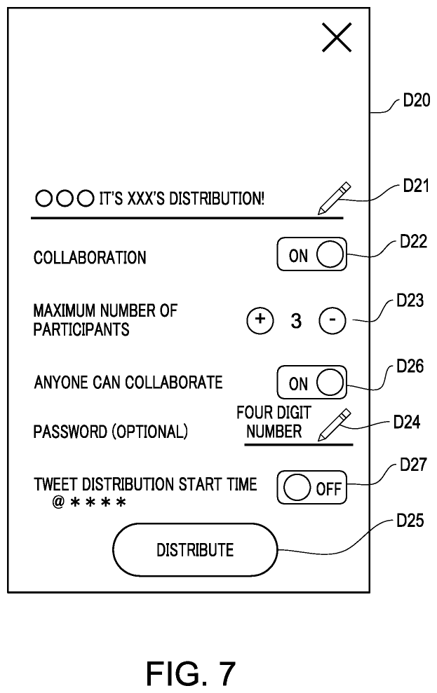

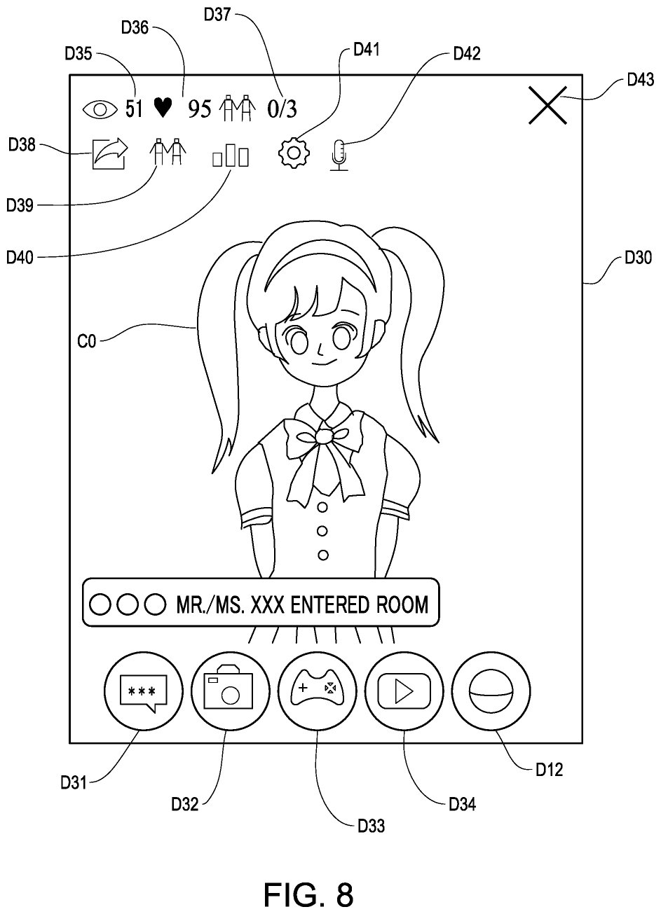

As an example, when the distribution preparation button T22 is selected on the top screen T10 shown in FIG. 5, the screen transitions to an avatar setting screen D10 shown in FIG. 6. Then, when a distribution button is selected on the avatar setting screen D10, the screen transitions to a distribution setting screen D20 shown in FIG. 7. Then, when a distribution start button D25 is selected on the distribution setting screen D20, the screen transitions to an avatar distribution screen D30 shown in FIG. 8.

Next, details of a flow up to the start of video distribution will be described.

The one or more computer processors in this disclosure may include a distribution start request receiving portion, a distribution setting portion, and a distribution start portion.

The distribution start request receiving portion receives a distribution start request for a first video including an animation of a character object from the distributing user terminal of the distributing user.

Here, the first video refers to a video including an animation of a character object. In this specification, the character object may be referred to as an “avatar.”

The above-described distribution start request can be sent from the user terminal to the information processing device 400 by selecting the distribution button D11 located on the avatar setting screen or the like that has transitioned from the top screen displayed on the user terminal (later to become the distributing user terminal) that started a dedicated application (video distribution/viewing application) for accessing the above-described video distribution platform,

FIG. 6 shows an example of the avatar setting screen D10. A character object CO, the distribution button D11, a gacha button Di 2, a clothes-changing button D13, a photo button D14, and the like can be displayed on the avatar setting screen D10.

When the clothes-changing button D13 is selected by the user, a closet screen for selecting various avatar parts such as eyes, nose, mouth, hair, accessories, clothes, and background of the character object CO appears.

When the gacha button 112, is selected by the user, a lottery screen for obtaining the above-described avatar parts appears.

When the photo button D14 is selected by the user, a capturing screen for capturing a still image of the character object appears.

When the distribution button D11 is selected by the user, a distribution start request is sent to the information processing device 400.

The distribution setting portion sets the distribution setting of the first video based on the designation from the distributing user terminal 100 in response to the distribution start request of the first video received by the distribution start request receiving portion.

As an example, when the distribution button D11 is selected, the screen displayed on the distributing user terminal 100 transitions from the avatar setting screen D10 shown in FIG. 6 to the distribution setting screen D20 shown in FIG. 7.

The distribution setting can include at least one of a setting related to the title of the first video, a setting regarding whether other users can appear in the first video, a setting related to the number of people who can appear in the first video, or a setting related to a password.

These distribution settings can be set in a title setting field D21, a collaboration possibility setting field D22, a number-of-people setting field D23, and a password setting field D24 in FIG. 7, respectively. Additionally, in FIG. 7, an anyone-can-collaborate possibility setting field D26 and an SNS posting possibility field D27 are further displayed.

The title of the first video can be freely determined by the distributing user within a range of a number of characters up to an allowable upper limit. If there is no input by the distributing user, a preset title, including the name of the distributing user or character object such as “This is so and so's distribution P,” may be determined automatically.

Whether other users can make a request for appearance in the first video can be freely determined by the distributing user. If yes, other users can make a request for appearance to the distributing user. If no, other users cannot make a request for appearance to the distributing user. A state in which another user appears in the video of the distributing user may be referred to as “collaboration” in this specification. Details of the collaboration will be described later.

The number of people who can appear in the first video can be set only when other users can appear in the first video mentioned above, and the distributing user can freely determine this number within a range of the number of people up to an allowable upper limit.

A password can be arbitrarily set only when other users can appear in the first video mentioned above, and the distributing user can freely determine the designated number of digits. When another user makes a request for appearance in the first video, entering of such a password is required. A configuration is acceptable in which the password setting field D24 may become active only when the anyone-can-collaborate possibility setting field D26 is OFF.

The distribution start portion distributes information about the first video to the viewing user terminal(s) 200 of the viewing user(s) based on the conditions set by the distribution setting portion.

The instruction to start such distribution is sent by selecting the distribution start button D25 shown in FIG. 7.

As an example, the distribution start portion distributes information about the video (first video) including the animation of the character object of the distributing user to the viewing user terminal 200 of the viewing user (avatar distribution).

Information about the first video includes, for example, motion information indicating movement of the character object, sound information of the distributing user, and gift object information indicating a gift sent from another viewing user. The gift object information includes at least gift object identification information that specifies the type of the gift object and position information that indicates the position where the gift object is to be displayed.

Then, the distribution start portion can live-distribute the video via the video distribution platform described above.

FIG. 8 shows the avatar distribution screen D30 displayed on the distributing user terminal 100.

In addition to displaying the character object CO on the avatar distribution screen D30, a comment input button D31 for the distributing user to input a comment, a photo button D32 for saving a still image of the screen, a play start button D33 for playing a game described later, an external service liaison button D34 for viewing a video provided by an external service, and the gacha button D12 for obtaining an avatar part can be displayed.

Additionally, a cumulative number-of-viewers display D35, a cumulative likes display D36, a number-of-collaborators display D37, a share button D38 for an external SNS, a guest details button D39, a ranking display button D40, a setting button D41, and a sound switching button D42 for switching sound ON/OF can be displayed. Further, an end button D43 for ending the distribution is also displayed.

Although detailed description of these displays and buttons is omitted, it is possible to change the distribution settings set on the distribution setting screen D20 by selecting the setting button D41.

FIG. 8 shows an example of starting distribution in which the distribution setting screen D20 allows other users to appear in the first video, and the number of people who can appear in the first video is three. Therefore, the character object CO is displayed in a state of being closer to the lower left. This is a state in which up to three character objects of other users are able to appear in a vacant space.

The above is a description of the screen transition when the avatar distribution in this disclosure is performed.

Subsequently, a screen transition when the distributing user plays a game during distribution will be described.

The one or more computer processors in this disclosure may include a game request receiving portion, a game video distribution portion, and a game display processor.

The distributing user can request to start playing a game by selecting the play start button D33 during avatar distribution such as is shown in FIG. 8.

The game displayed by selecting the play start button D33 can be a dedicated game implemented in the application realized by the information processing system in this disclosure, and can be different from a general-purpose game provided by an external service. Therefore, the game distribution in this disclosure may be distinguished from the distribution of a general-purpose game play video provided by an external service together with a live broadcast of the distributing user.

Alternatively, the play start request may be sent from the distributing user terminal 100 to the information processing device 400 by selecting the play start button arranged on a predetermined screen displayed on the distributing user terminal 100 of the distributing user.

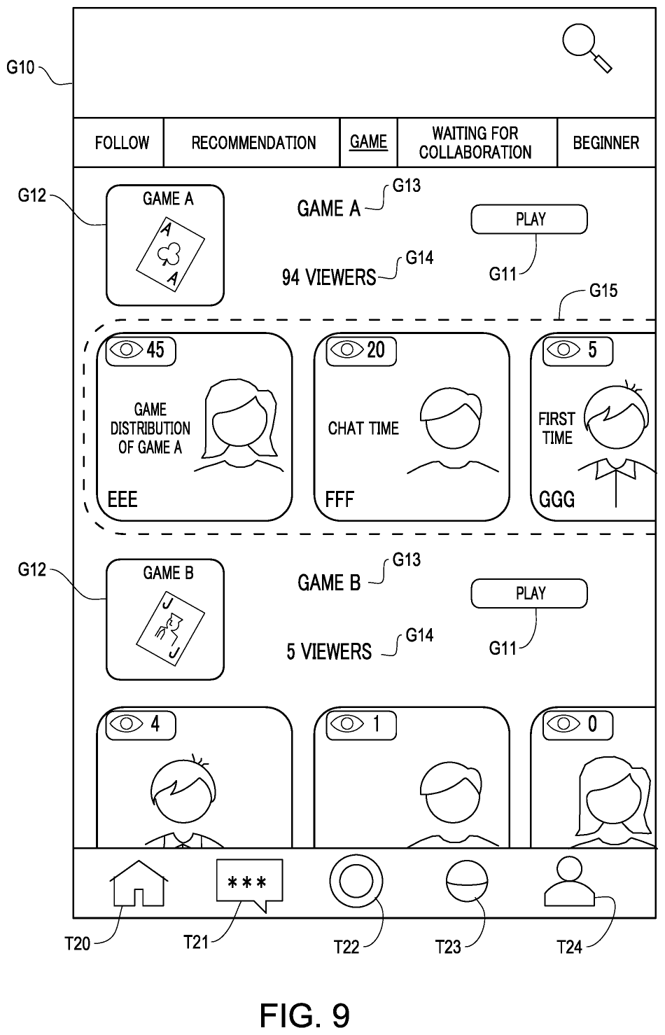

FIG. 9 shows an example of a screen G10, in which a play start button G11 is arranged, as the predetermined screen. The screen G10 shown in FIG. 9 is a screen that has transitioned from the top screen T10 (FIG. 5) displayed on a user terminal that has started the application realized by the information processing system in this disclosure by selecting the game tab T15.

At least the play start button G11 that can send a request to start play of a predetermined game is displayed on the screen G10.

Then, when the game request receiving portion receives the request to start play of the predetermined game, the game video distribution portion distributes information about a second video to the viewing user terminal.

Here, the second video is a play video of a predetermined game. In this specification, distributing a video so that it is displayed on the screen of the viewing user terminal 200 is called “game distribution.”

Further, as a distributing user, after starting the application realized by this disclosure, the user can send the request for the start of distribution of the second video to the information processing device 2400 by selecting a play start object arranged on the game list screen and the game detail screen.

The game list screen or the game details screen is a first screen to be described in detail below.

That is, the game display processor performs display processing of the first screen including (i) a distribution start object that can send a distribution start request, (ii) a play start object that can send a play start request for a predetermined game, and a thumbnail image of a video that is distributing a play video for a predetermined game.

The screen G10 shown in FIG. 9 corresponds to the game list screen of the first screen. The first screen, which is the game list screen, is a screen that has transitioned from the top screen T10 by selection of the game tab T15.

The first screen includes (i) the distribution preparation button T22 as a distribution start object, (ii) the play start button G11 as a play start object, and (iii) a thumbnail image showing a distribution channel of a video.

On the first screen, for each of a plurality of playable games, the play start button G11, a game icon G12, a game name G13, a total number-of-viewers G14 of the distribution channel of the game, and a distribution list G15 including thumbnail images of the distribution channels during the game distribution are displayed.

The order of the thumbnail images displayed in the distribution list G15 displayed here may be different depending on the viewing user. As an example, the thumbnail images are arranged in the order of (i) the order in which the number of viewing users following and the number of views by those viewing users are highest, (ii) the order in which the cumulative number of viewers is highest, and (iii) the order in which the distribution start is oldest. Additionally, the display range of the thumbnail images of the distribution list G15 can be changed by horizontal scrolling.

Additionally, the games displayed on this game list screen will read the top 10 titles with the following priorities. As an example, the priority is determined by (i) the order by newest date within 48 hours from the game distribution start, date and time, and in which a viewing user last played within 30 days, (ii) the order of highest priority of a period ID, and (iii) the descending order of the period. ID.

This distribution list G15 will be updated (i) when returning from the screen of another tab and (ii) when a refresh operation (Pull-to-Refresh) has been performed.

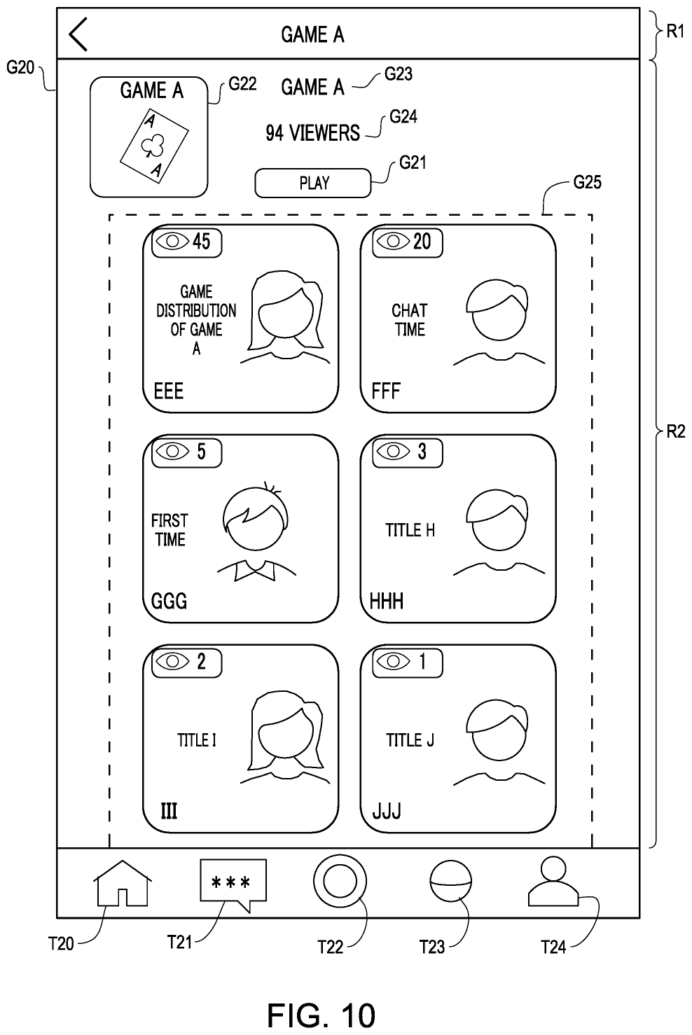

FIG. 10 corresponds to a game detail screen of the first screen. The first screen, which is the game detail screen, is a screen that has been transitioned to by selecting a game icon G12 or a game name G13 displayed on the game list screen shown in FIG. 9, and is G20.

The first screen includes the distribution preparation button T22 which is a distribution start Object, a play start button G21 which is a play start object, and thumbnail images showing video distribution channels.

Further, on the first screen, a game icon G22, a game name G23, a total number-of-viewers G24 of the distribution channel of the game, and a distribution list G25 including thumbnail images of the distribution channels that are distributing the game are displayed.

The order of the thumbnail images displayed in the distribution list G25 displayed here may be different depending on the viewing user. As an example, the order is arranged in the order of (i) the order in which the number of viewing users following and the number of views by the viewing users is highest, (ii) the order in which the cumulative number of viewers is highest, and (iii) the order in which the distribution start is oldest. Additionally, the display range of the thumbnail images of the distribution list G25 can be changed by vertical scrolling.

This distribution list G25 will be updated (i) when returning from the screen of another tab and (ii) when a refresh operation (Pull-to-Refresh) has been performed.

As described above, a user who selects the distribution start object or the play start object becomes a distributing user who makes the distribution start request or the play start request.

Further, a user who selects a thumbnail image becomes a viewing user who views the second video.

Further, the first screen includes a first region in which a scrolling operation is not possible and a second region in which a scrolling operation is possible.

The first screen referred to here is the first screen shown in FIG. 10, The first screen includes a first region R1 and a second region R2. Specifically, the game title is displayed in the first region R1, and the play start button G21, the game icon G22, the game name G23, the number of viewers G24, and the distribution list G25 described above are displayed in the second region R2.

The first region R1 is a portion in which a scrolling operation is not possible, and is fixedly displayed on the display screen, and the second region R2 is a portion in which a scrolling operation by the user is possible. By scrolling the second region R2, the user can check the thumbnail images hidden outside the screen.

However, since the play start button G21 may be hidden outside the screen by scrolling in the second region, the display processor in this disclosure can display a play start object (play start button G21) in the first region R1 according to a display state of a play start object (play start button G21) displayed in the second region R2.

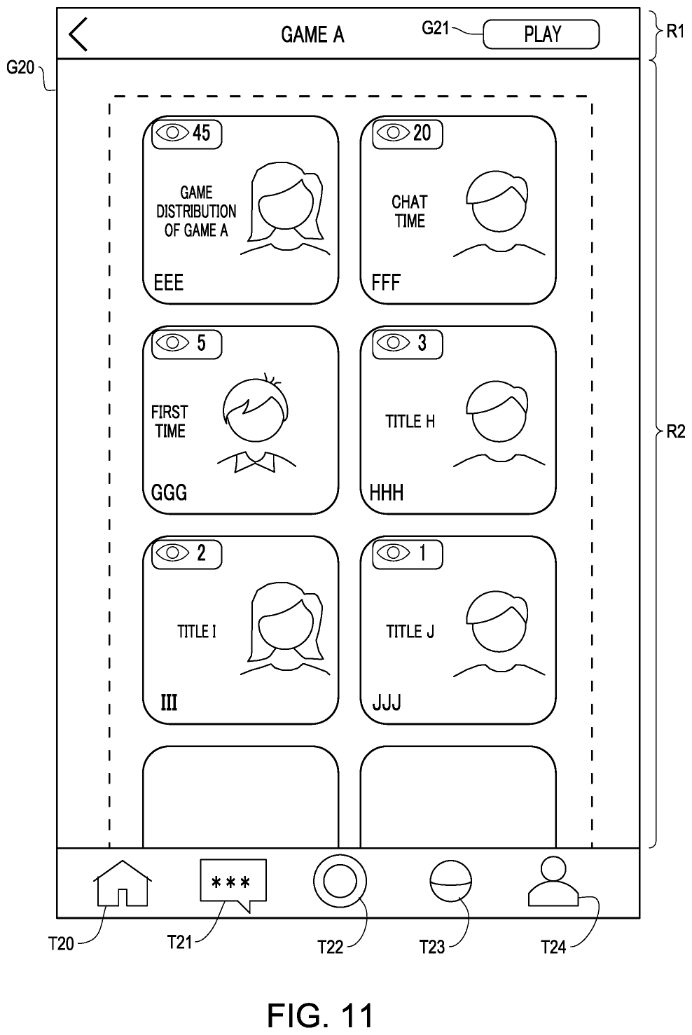

As an example, in FIG. 10, the play start button G21 is displayed in the second region R2, but in FIG. 11, it is displayed in the first region R1. That is, when part or all of the play start button G21 is not displayed in the second region R2, the play start button G21 appears in the first region.

Further, the game display processor may display the play start object in the first region R1 in stages according to the display state of the play start object displayed in the second region R2.

Such an expression can be realized by changing the transparency of the play start object according to the scroll amount of the second region R2.

As an example, a scroll amount (unit is pixels) of 0 to 50 is caused to correspond to a button transparency of 0.0 (completely transparent) to 1.0 (completely opaque). Thus, in the initial display state, the object is completely transparent and cannot be seen, and when scrolling by 50 pixels or more has been performed, the object is completely displayed. During that scrolling (0 to 50), it is preferable to change the transparency of the object linearly. The unit of the scroll amount is a logical pixel, which may be different from an actual pixel of the display.

Further, the game request receiving portion can accept a play end request for a predetermined game from the distributing user terminal 100 after the game video distribution portion distributes information about the second video.

The play end request can be sent by selection of an end button arranged on the game screen.

Then, when the game request receiving portion receives the play end request of the predetermined game, the video distribution portion can end the distribution of the information about the second video and distribute the information about the first video.

That is, what is distributed here is not part of the information of the first video, but all the information of the first video.

Then, when the video distribution portion ends the distribution of the information about the second video and distributes the information about the first video, what is displayed on the viewing user terminal 200 is the first video.

The following is an explanation of a flow to start viewing the video.

The one or more processors in this disclosure may further include a viewing receiver.

The viewing receiver receives a video viewing request from a user.

The video distribution portion distributes video and sound information as video information to the user's information processing terminal in response to the viewing request.

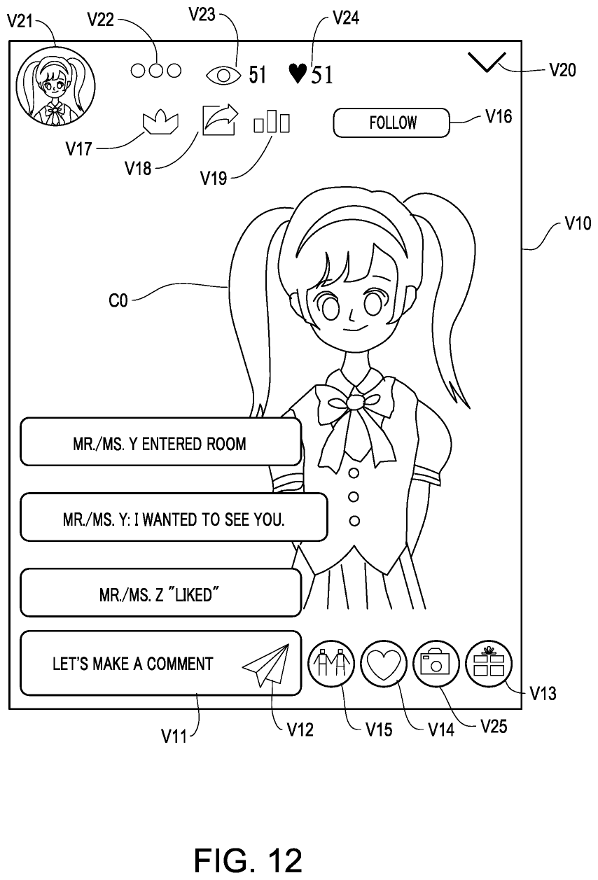

FIG. 12 is an example showing a viewing screen V10 of an avatar video displayed on the viewing user terminal 200.

The viewing user can post a comment by inputting text in a comment posting field. V11 and pressing a send button V12.

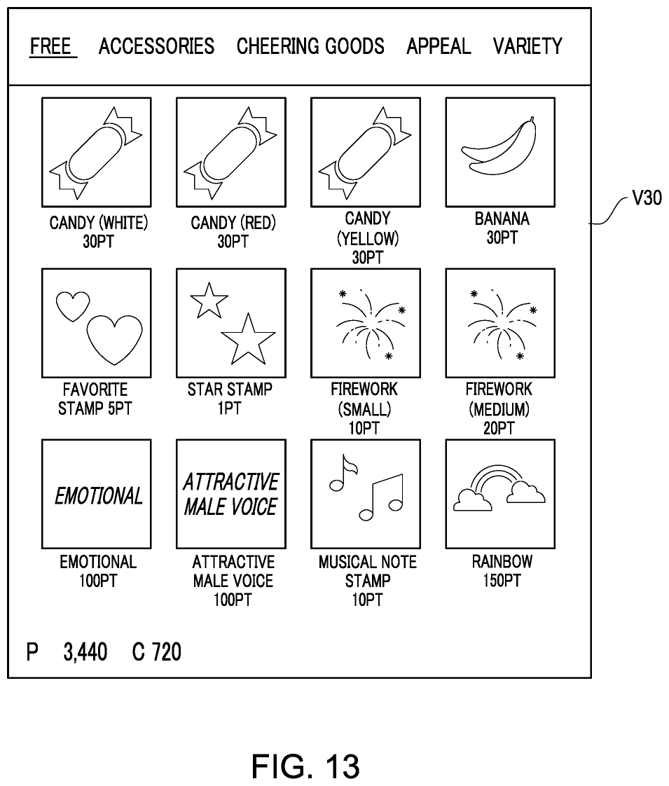

Further, by pressing a gift button V13, a gift list (screen V30 in FIG. 13) is displayed to the viewing user, and a display request for a gift designated by selection can be sent.

At this time, the one or more processors in this disclosure may include a determination portion. The determination portion determines whether there is a gift display request from the viewing user terminal 200.

The display request can include gift object information. The gift object information includes at least (i) gift object identification information that specifies the type of the gift object and (ii) position information that indicates the position where the gift object is to be displayed.

Further, as shown in FIG. 13, gifts can be displayed separately for each category (free (paid) gifts, accessories, cheering goods, appeal, variety, or the like).

Here, a paid gift is a gift (coin gift) that can be purchased by the consumption of “My Coin” purchased by the viewing user. A free gift is a gift (point gift) that can be obtained with or without consumption of “My Points,” which the viewing user has obtained for free.

The term “gift” used in this application means the same concept as the term “token” Therefore, it is also possible to replace the term “gift” with the term “token” to understand the technology described in this application.

Furthermore, the viewing user can post a rating showing favor by pressing a like button V14. In addition to/in place of the like button V14, it is also possible to display a button for posting a negative evaluation or other emotions.

Additionally, in the distribution settings, if the distributing user has performed a setting to allow other users to appear, a request for appearance in the video can be sent by selecting a collaboration request button \115.

Additionally, a follow button V16 for the viewing user to follow the distributing user is displayed on the screen of a video distributed by a distributing user that the viewing user has not yet followed. This follow button functions as a follow release button on the screen of a video distributed by a distributing user that the viewing user is already following.

This “follow” may be performed from a viewing user to a viewing user, from a distributing user to a viewing user, and from a distributing user to a distributing user. However, this “follow” is managed as a one-way association, and a reverse association is managed separately as a follower.

Additionally, a photo button V25 for saving a still image of the screen can also be displayed.

Further, a cheering ranking display button V17, a share button V18, and a ranking display button V19 are also displayed on the viewing screen V10.

The cheering ranking displays the ranking of the viewing user who cheers the distributing user, and the ranking can be calculated according to the amount of gifts (points/coins) or the like.

Additionally, regarding the sharing of videos, by pressing the share button V18, the viewing user can check a list of SNS (Social Networking Services) that can be shared, and can send a fixed link to a designated location of the SNS designated by selection.

Furthermore, by pressing the collaboration request button V15, it is possible to request collaborative distribution from the distributing user. Collaborative distribution means that the character object of the viewing user is caused to appear in a distributed video of the distributing user.

At the top of the viewing screen V10, a distributing user icon V21, a distributing user name (character object name) V22, a cumulative number-of-viewers display V23, and a cumulative number-of-likes display V24 can be displayed.

Further, when the viewing end button V20 is selected, a screen for ending viewing appears, and a viewing end request can be sent.

The screen for ending such viewing will be described in detail. Such a screen is called “small window sound distribution,” and is for viewing a video in a manner of playing only the sound without displaying the image of the video.

The selection of the viewing end button V20 is accepted by the viewing receiver as a video viewing end request.

At this time, the video distribution portion ends the distribution of the image-related information in response to the viewing end request, but does not end the distribution of the sound-related information.

Thus, when the image- and sound-related information are distributed at the user terminal, the image is displayed on the main screen at the user terminal, and when only the sound information is distributed, the image is not displayed at the user terminal and a sub screen indicating that the video is being viewed is displayed.

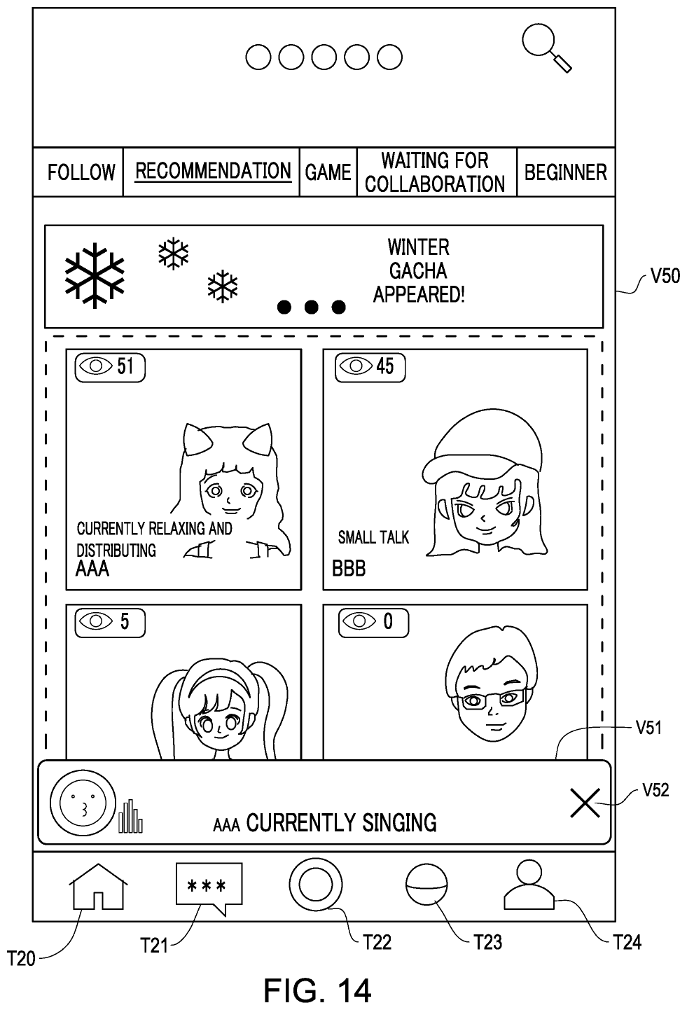

FIG. 14 shows an image of a screen V50 on which a sub screen V51 is displayed.

When this sub screen V51 is displayed, the main screen displayed at the back transitions to the screen before viewing the video. For example, when moving from a recommendation tab to the viewing frame, the display returns to the recommendation tab, and when moving from the follow tab to the viewing frame, the display transitions to the follow tab.

When this sub screen V51 is being displayed, operation on the main screen becomes possible, and transition to another screen becomes possible.

On the sub screen V51, a profile image, a name, a title, and a sound icon that can visually identify that sound is playing are displayed.

Then, by selecting an end icon V52 displayed on the sub screen V51, the viewing can be completely ended.

Regarding the end of the display of the image, the information may be sent from the server device, but not displayed at the terminal side, or the transmission of the information itself from the server device may be stopped.

With such a configuration, it becomes possible to search for other distributions and enjoy chatting with other users while listening only to sound.

Next, a “collaboration” in which another user appears in the video of the distributing user will be described.

As described above, the viewing user can send a request to participate in the video via the confirmation screen of the collaborative distribution participation request, which is displayed by pressing the collaboration request button V15 shown in FIG. 12.

A collaboration avatar display portion included in one or more computer processors in this disclosure causes a character object generated based on the movement of the viewing user who made the participation request to be displayed in the video, in response to the received participation request.

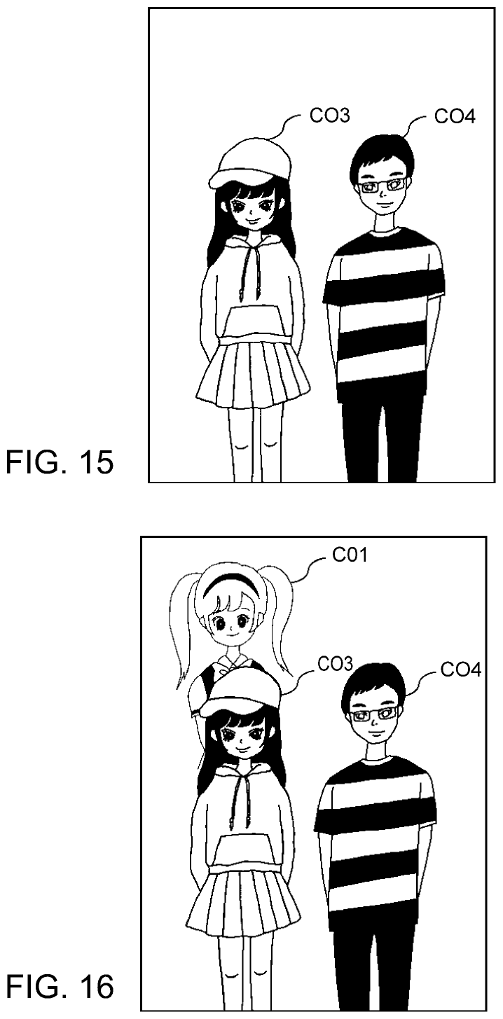

FIG. 15 shows, as an example, a viewing or distribution screen when a second avatar CO4, which is a character object of a guest user, participates in a video in which a first avatar CO3, which is the character object of the host user, is displayed. In FIG. 15, the display of objects other than the avatars is omitted.

Further, as shown in FIG. 16, a third avatar CO1, which is a character object generated based on the movement of another viewing user, may participate in the video. Additionally, although the third avatar CO1 is arranged behind the first avatar CO3 and the second avatar CO4 in FIG. 16, the three people may be arranged so as to line up in a horizontal row. Further, the arrangement position of the avatars may be designated by the distributing user.

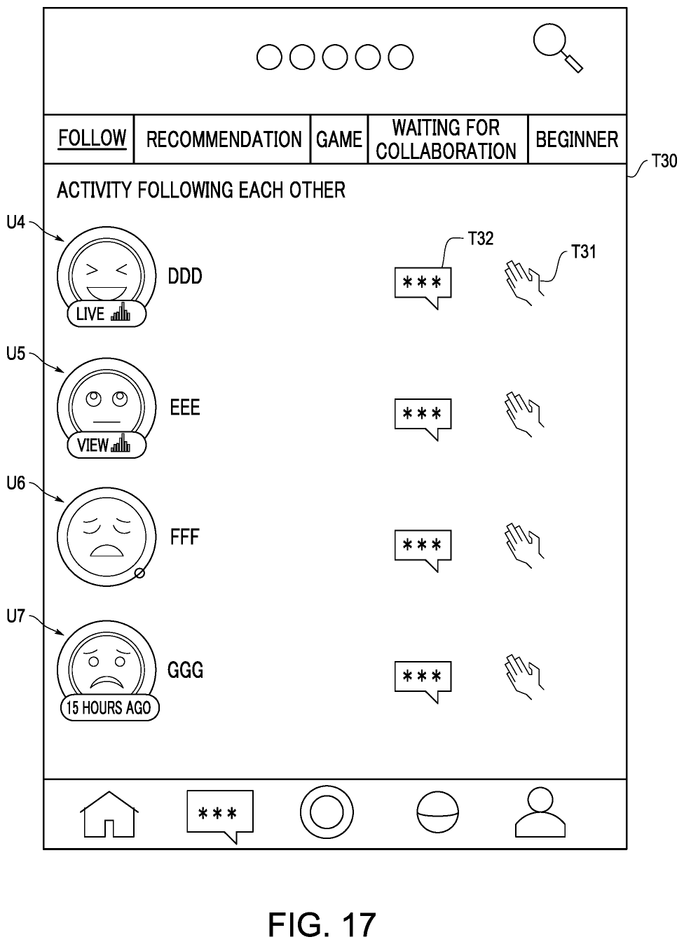

FIG. 17 shows a list screen T30 of users having a mutual follow relationship, which is displayed by selection of the follow tab on the top screen shown in FIG. 5. Mutual follow is a relationship in which each is a follower of the other.

On the list screen T30, profile images and names of users who have a mutual follow relationship are displayed.

As shown in FIG. 17, a first object T31 is displayed on the list screen T30 for each of the users having a mutual follow relationship. Further, a chat object T32 may be displayed together with the first object T31. By selecting this chat object, it is possible to transition to an individual chat screen with a second user.

Selecting the first object T31 sends a predetermined notification to the terminal of the user associated with the first object T31.

The predetermined notification may be, for example, a call notification.

Nest, a detailed description of a flow for executing a video chat in an embodiment of this disclosure will be explained.

As an example, a user can execute a video chat from an individual chat screen or a group chat screen.

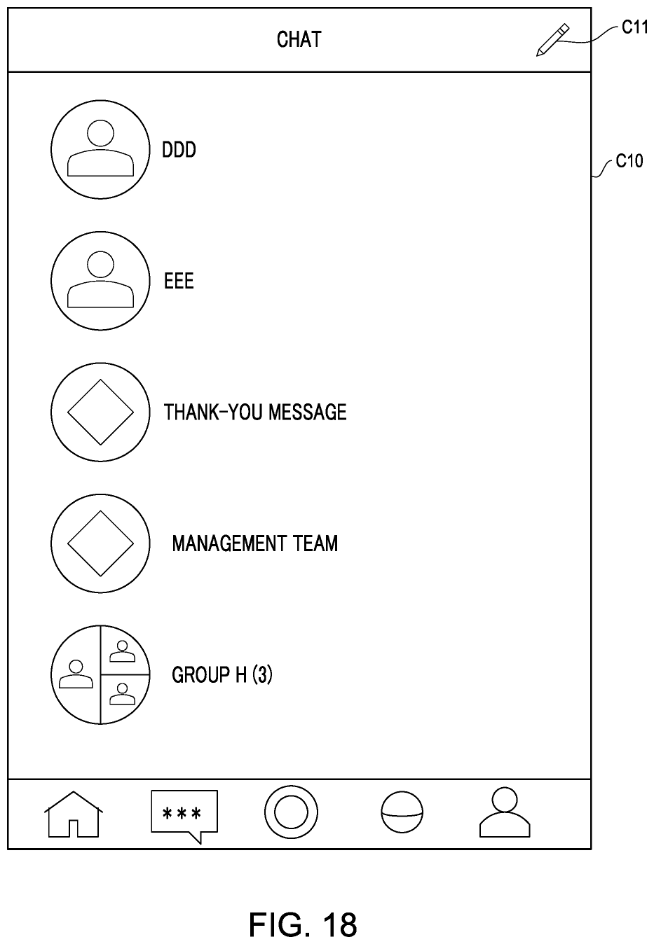

These chat screens can be transitioned to, for example, from a chat list screen C10 (FIG. 18) expanded by selecting the message button T21 on the top screen T10 (FIG. 5).

The chat list screen C10 shown in FIG. 18 displays icons of users (character objects) or icons of groups that have sent or received messages (chats) in the past, along with their names or titles. The icons of groups can include icons of users (character objects) participating in the groups.

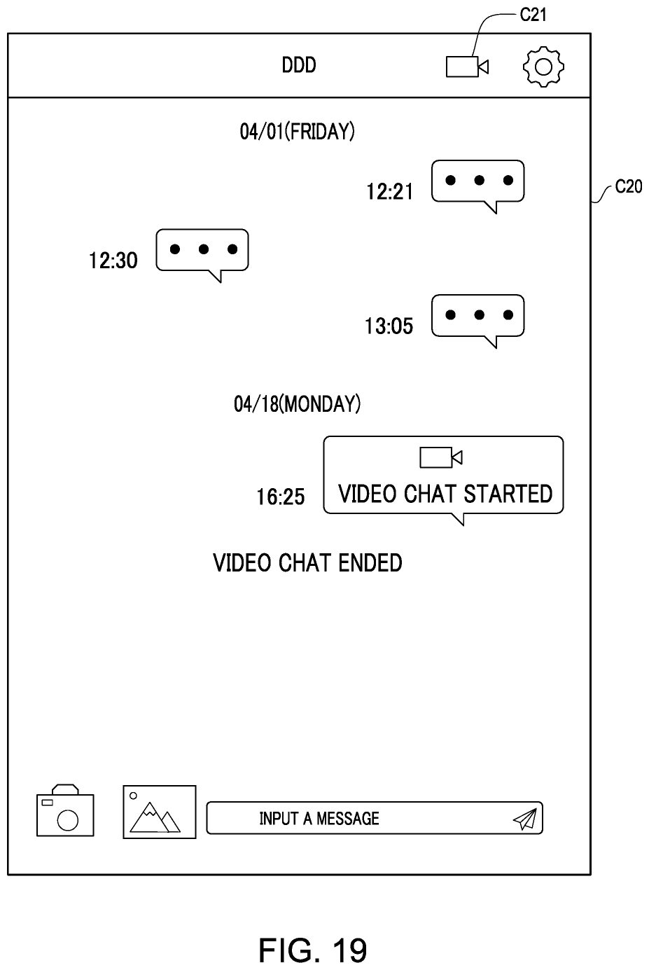

The user can then select one user or group on the above-described chat list screen C10, open an individual chat screen C20 (FIG. 19) or a group chat screen, and select a video chat button C21 to start a video chat.

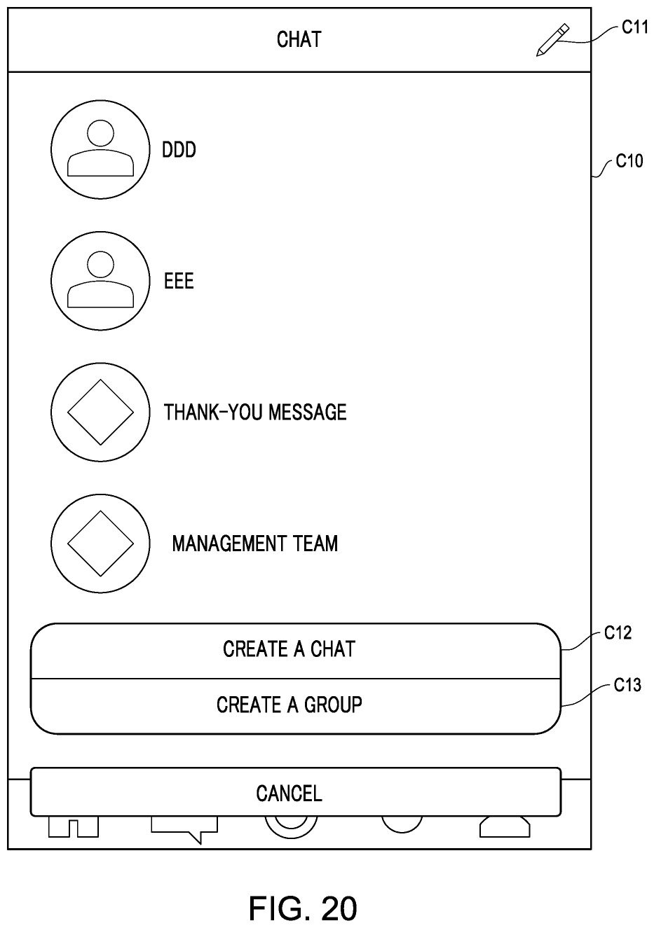

Additionally, by selecting a chat creation button C12 or a group creation button C13 displayed by selecting an edit button C11 on the chat list screen C1.0 (FIG. 20), a chat screen of a user or group not displayed on the chat list screen C10 can be created.

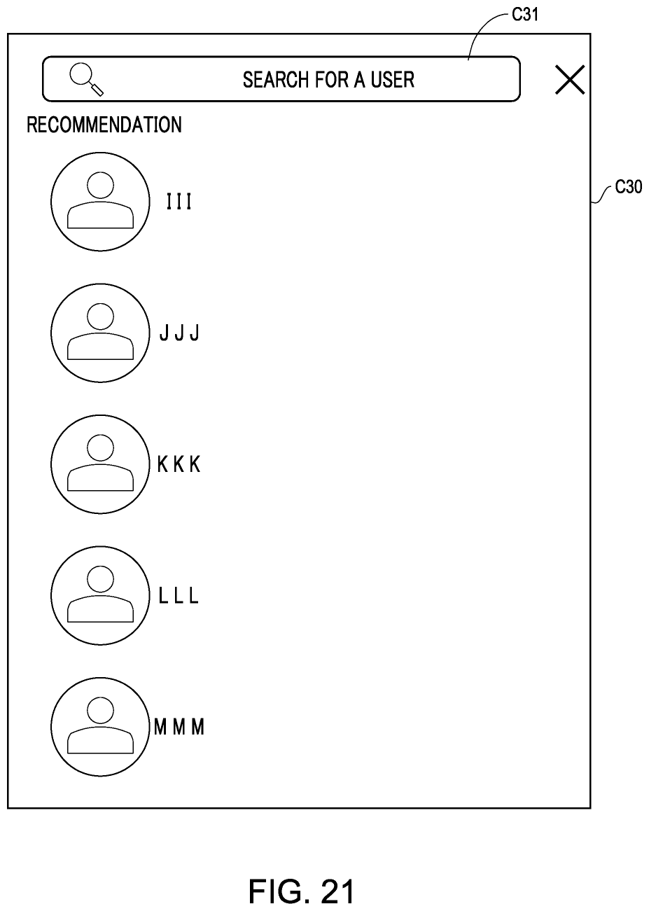

FIG. 21 is a user selection screen C30 that develops when the chat creation button C12 is selected, and a chat screen with a recommended user(s) that is being displayed or a user searched for using a search field C31 is displayed/generated. A configuration of the generated chat screen is the same as the chat screen C20 shown in FIG. 19, and video chatting can be started by selecting the video chat button C21.

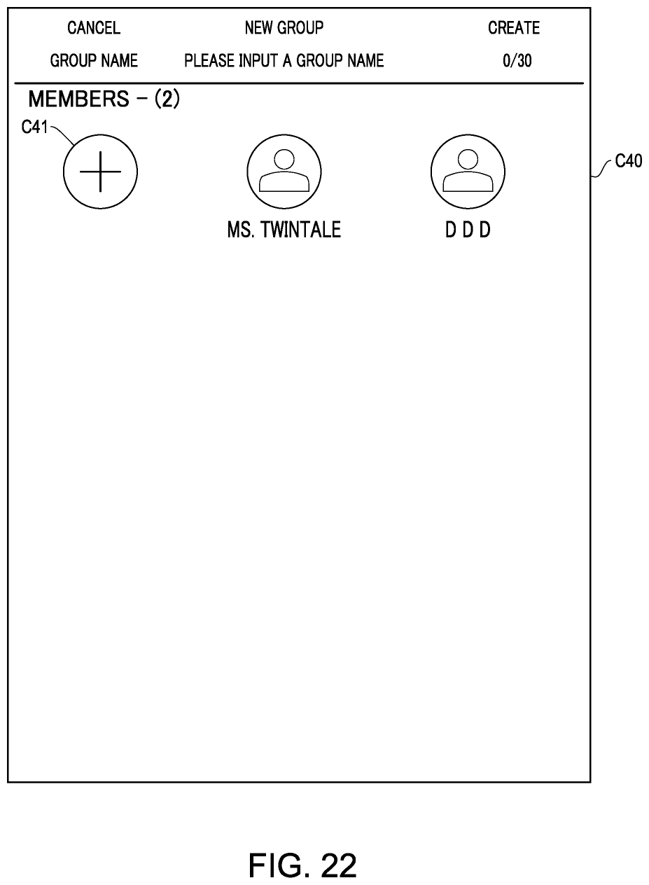

Similarly, FIG. 22 shows a group creation screen C40 that develops when the group creation button C13 is selected. The user can add users other than himself/herself as group members by selecting a user addition button C41. As an example, the number of group members that can be added is up to 7. A group name can also be set on this screen.

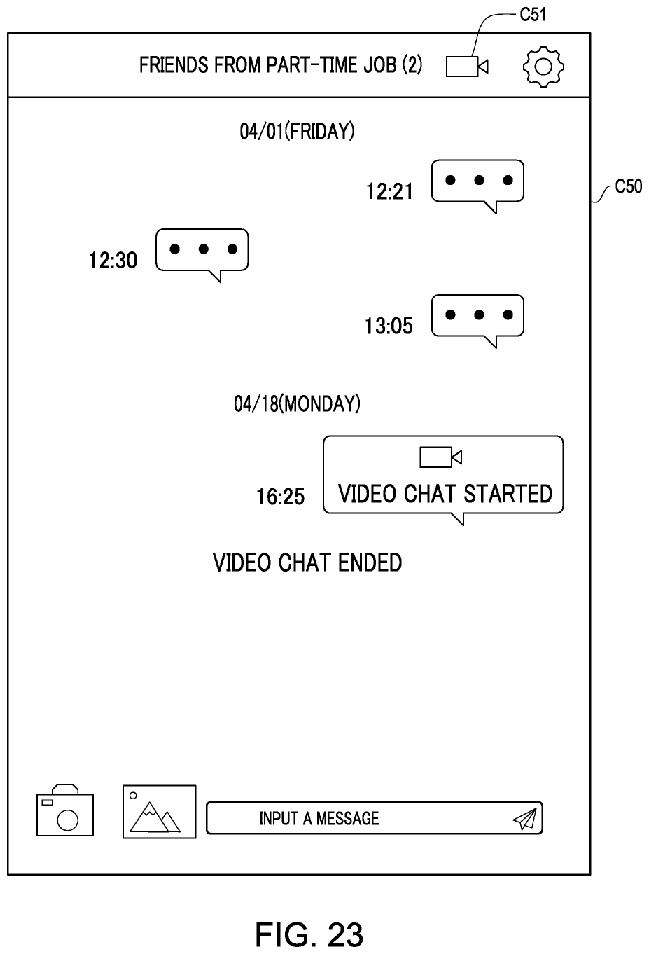

Once a group is created, a group chat screen C50 is displayed (FIG. 23). In the group chat screen C50 as well, video chatting can be started by selecting a video chat button C51.

Furthermore, the above chat screen C20 can be transitioned to from the chat icon T32 of the follow list screen T30 (FIG. 17).

Also, a chat icon can also be arranged on a profile screen of another user, and the user can transition from various pages to a chat screen, and a video chat can be started.

When a video chat is started, a notification is sent to the other party, and the other party can participate in the video chat by responding to the notification. Users can set whether or not to receive such notifications.

Furthermore, the system may be configured to allow video chatting only with users who are in a mutual follow relationship. In this case, the system may be configured to display an icon on the follow list screen indicating that a user in a mutual follow relationship is in a video chat with another user, and a user may select the icon to participate in such an ongoing video chat.

The video chat in this disclosure can be said to be a function that allows only a specific user to view the collaborative distribution described above. The specific user here refers to a user participating in a video chat.

Next, with reference to the drawings, various functions that can be executed in the information processing system 3000 of an embodiment of this disclosure will be explained.

Furthermore, in this embodiment, the explanation will be given on the assumption that the distributing user terminal 100 provided with the information processing system 3000 is the user terminal of the user participating in the video chat, but there is no particular distinction between the distributing user terminal 100 and the viewing user terminals 200 when executing the video chat.

That is, the video chat in the embodiment of this disclosure can be part of a function incorporated into a system that distributes video as described above, or it can be realized as an independent system specialized for video chatting using an avatar(s).

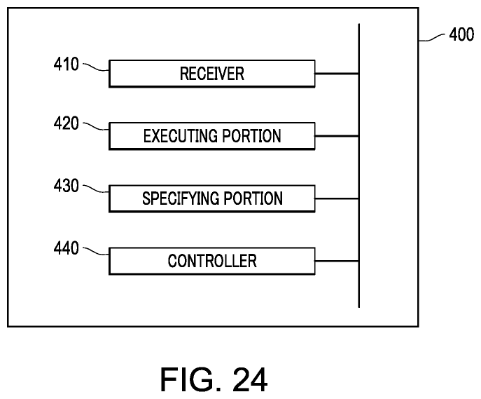

One or more computer processors provided by the information processing system 3000 in the embodiment of this disclosure have a receiver 410, an executing portion 420, a specifying portion (identifying portion) 430, and a controller 440, as shown in FIG. 24.

The receiver 410 can receive information for generating a video, including information related to movements of the user, information related to sound, and information related to a character object(s), that is sent from a user terminal of the user.

Additionally, in the above explanation of avatar distribution, information related to the video (information for generating a video) was described as including motion information indicating movement of a character object(s), sound information of the distributing user, and gift object information indicating a gift(s) sent by other viewing users, and the like. Here, it is assumed that at least information related to movements of the user, information related to sound, and information related to a character object(s) are included.

Information related to movements of the user can include, as an example, information related to at least the user's facial movements captured by a camera provided by the user terminal or connected to the user terminal.

As an example, the information related to sound includes information related to (i) sound that corresponds to speaking by the user, as collected by a microphone provided by the user terminal or connected to the user terminal and/or (ii) another sound other than that through speaking by the user.

The other sound is, for example, another user's voice or an environmental sound. By using known speech recognition technology, it can be identified whether the utterance is made by the user or by another user. Additionally, the environmental sound includes a TV sound, an intercom sound, telephone ringing sound, animal noises, sound of a train station announcement, sounds of trains, cars, motorcycles, and the like, sounds of multiple people talking, or the like.

The executing portion 420 causes the execution of a video chat among a plurality of users using character objects, based on the information received by the receiver 410 for generating the video.

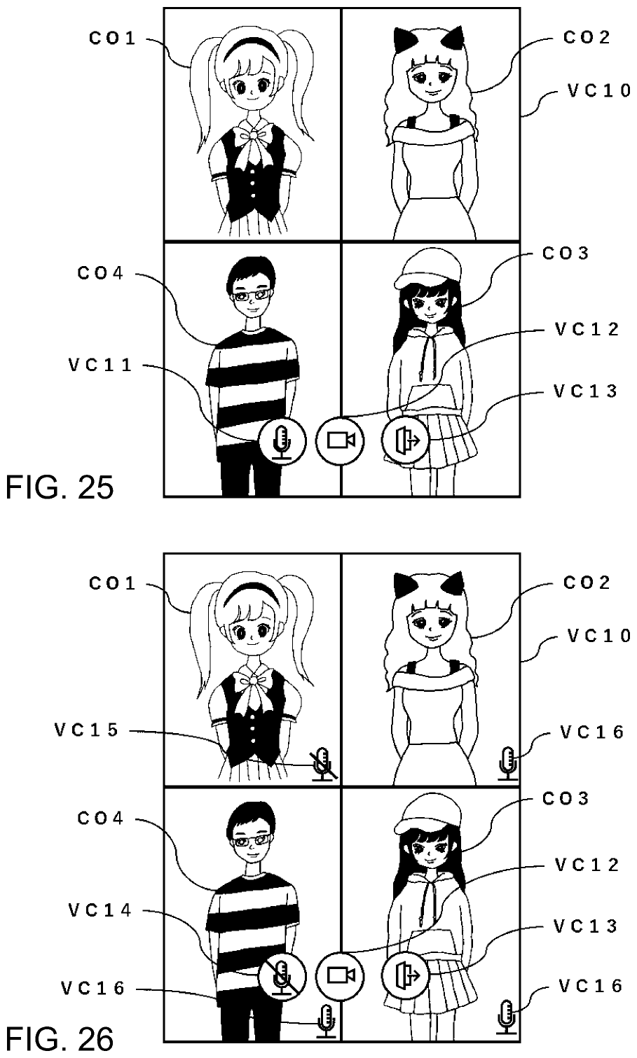

FIG. 25 shows an example of an image of a video chat screen VC10 where a video chat is in progress.

FIG. 25 shows an example of four users participating in a video chat using character objects CO1, CO2, CO3, and CO4. The video chat screen VC10 may be configured so that a display frame is divided according to the number of participants, or a plurality of people may be displayed together on a single screen.

In the example shown in FIG. 25, the video chat screen VC TO is divided into four display frames. The number, shape, size, and the like of such display frames are not limited to those shown in the figure, and may change in real time according to the state of the user's user terminal that will be described later.

Furthermore, the users participating in a video chat can be constituted by an initiating user who starts the video chat and a participating user(s) who participates in the initiated video chat. In the example shown in FIG. 25, the character object CO1 corresponding to the initiating user is displayed in the upper left corner, but the display location of these users is not limited to the one shown in the figure and may change in real time according to the state of the user's user terminal that will be described later.

The user terminal of the initiating user sends information for generating the above-described video to the server device when the video chat is started. Also, the user terminals of the participating users respond to the notification of the start of the video chat, and send information for generating the above-described video to the server device when participating in the video chat.

The user terminal has an image capturing function through a camera and a sound capturing function through a microphone, and image/sound data captured/collected by these functions are sent to the server device via the network. Whether or not these data can be sent to the server device can be switched by selecting, by user operation, a video object VC12 and a microphone object VC11 that are displayed on the video chat screen VC10.

Alternatively, the video object VC12 and the microphone object VC11 that are displayed on the video chat screen VC10 may be selected by user operation to switch these functions on and off at the user terminal.

Additionally, an exit object VC13 is used to leave the video chat.

In this embodiment, the description will be made using the expression that the camera is switched on/off and/or the microphone is switched on/off, including both cases of (i) sending to the server device being possible or not, and (ii) switching on/off of functions at the user terminal, as described above.

Furthermore, not only can the video object VC12 and/or the microphone object VC11 be selected by user operation, but the camera can also automatically be switched on/off and/or the microphone can automatically be switched on/off, without user operation. For example, a configuration may be used such that depending on whether the screen displayed at the user terminal is the video chat screen VC10 or another screen, the camera can be automatically switched on/off and/or the microphone can be switched on/off, without user operation.

FIG. 26 shows an example of the display when the microphone is turned off at the user terminal corresponding to the character object COT. The microphone object VC11 changes to an object VC14 with a slanted line, and an icon VC15 indicating that the microphone is off is displayed at a position associated with character object CO1. An icon VC16 indicating that the microphone is on may be displayed at positions associated with the character objects CO2, CO3, and CO4, for which the microphones are on.

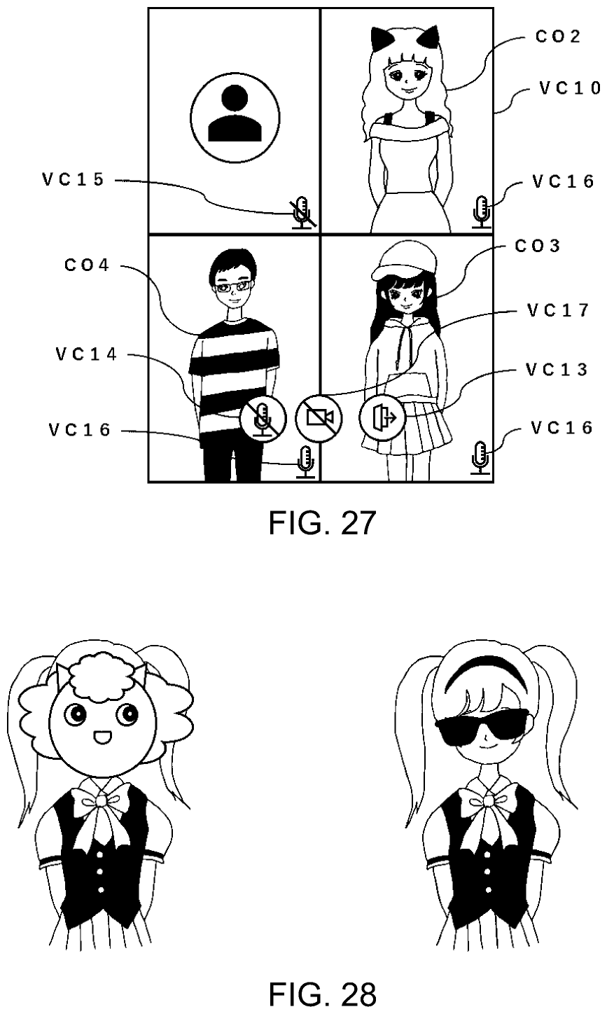

FIG. 27 shows a typical example of the display when the camera is off at the user terminal corresponding to the character object CO1. At this time, the video object VC12 changes to an object VC17 with a slanted line.

Thus, in a typical case, when the camera is turned off at the user terminal, another image, such as a profile icon of the user (character object), is displayed. It is also typical that this other image is constantly displayed the same regardless of whether the microphone is turned on or off.

However, it is difficult to understand the actual state of the user with such a display. There are various actual states of the user, such as whether the user is simply viewing a video chat with the camera turned off (and with the microphone turned off), or whether the user has actually disappeared from the front of the user terminal, and the like. Rigidly displaying a profile icon as described above may hinder communication among users participating in the video chat, as conversations may not be properly established.

Another problem unique to a video chat using character objects is that it is possible to continue displaying the character objects without information about the movements of the user. In this case as well, there is still a risk that the conversation may not be properly established and communication between the users participating in the video chat may be hindered.

Such communication hindrance among the users participating in a video chat may discourage the users from participating in the video chat, and is one of the problems that need to be resolved.

For this reason, the specifying portion 430 in this embodiment specifies the state of the user terminal.

Here, the state of the user terminal includes the state of the user who operates the user terminal.

For example, the state of the user can be categorized primarily as whether s/he is able/unable to view the video chat screen, hear sounds, speak, and the like.

Such a state includes a case in which a user is video chatting while playing a game, while playing music, or while playing a video, and the like, by executing an application different from the application for video chatting in this embodiment at the user terminal.

Additionally, the above-described state may also include a case in which the user is video chatting while opening another screen in the video chatting application of this embodiment. The other screen includes, for example, a closet screen for changing the character object's clothes or the like, a game screen, a menu screen, a screen for viewing a distributed video, and the like.

Furthermore, the above-described state may include a case in which sounds around the user are distracting the user, and the like. The sounds around the user include another user's voice, environmental sounds, and the like.

In embodiments of this disclosure, these states can be assumed by specifying the state of the user terminal.

States of the user terminal are described in embodiments below, with the examples of first through eighth states. The states of the user terminal are not limited to these states, and the display modes described below can be changed according to various possible states.

Then, the controller 440 in this disclosure changes the display mode of the character object corresponding to the user terminal according to the state of the user terminal specified by the specifying portion 430.

Changing the display mode includes (i) superimposing or combining another object on the character object and (ii) applying to the character object a specific movement prepared in advance, instead of user motion tracking.

Changing the display mode according to the state of the specified user terminal includes, for example, (i) changing the character object to a character object that wears an object to express (a) a state in which a video chat screen cannot be viewed, (b) a state in which sound cannot be heard or spoken, or the like, and (ii) changing from a character object to which the user's motions are applied to a character object to which is applied a movement that expresses (a) a state in which the video chat screen cannot be viewed, (b) a state in which sound cannot be heard or spoken, or the like.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

The specifying portion 430 can specify that the user terminal is in the first state if the receiver 410 has not received information related to the user's movement from the user terminal or if the information related to the user's movement received by the receiver 410 meets a first condition.

Examples of the case in which the receiver 410 is not receiving information related to the user's movement from the user terminal include (i) the case in which the video is turned off, or (ii) the case in which the video is on, but due to communication or other reasons, the receiver 410 is not receiving information related to movement, or the like.

An example of the case in which the information related to the user's movement received by the receiver 410 meets a first condition is that the camera at the user terminal is on and information related to the user's movement is being received, but it is determined that there is no movement, or the like.

As an example, the first condition is that the receiver 410 continues to receive information related to the same movement for a predetermined period of time, or does not receive information related to an amount of change in the movement, which is sent only when the movement has changed, for a predetermined period of time.

The same movement is a movement of an extent at which it is determined that there is no movement. The extent of such movement may be determined by image analysis, or may be determined by quantifying the movement. Also, the predetermined time here can be set to, for example, about five minutes, but is not limited to this, and may be set by the user.

In addition, if the user terminal sends the amount of change in movement only when the user's movement changes, the first condition is that information related to the amount of change is not received. Also, the predetermined time here can be, for example, about five minutes, but is not limited to this, and may be set by the user.

When the specifying portion 430 specifies that the user terminal is in the first state, the controller 440 can attach a first specific object to the character object and/or apply a first specific movement to the character object, as a change in the display mode of the character object.

The first specific object can be, for example, an object to indicate that the character object is not looking at the video chat screen.

Objects used to indicate that the character object is not looking at the video chat screen include, as an example, objects that cover at least the eyes of the character object, such as a mask object or sunglasses object as shown in FIG. 28.

These attached objects can be displayed in association with a specific part of the character object.

Such a specific part can be a part related to the state (here, the first state) of the user terminal, for example, a part (for example, eyes or face) related to the act of “looking” when the character object is shown not looking at the video chat screen.

The first specific movement is a movement used to indicate that the character object is not looking at the video chat screen.

An example of a movement used to indicate that the character object is not looking at the video chat screen includes a movement of covering the eyes or face with a hand.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

In addition, according to the above-described configuration, there is also an advantage that it is possible to display a wide variety of avatars with low load compared to the case of displaying a character object that moves its eyes according to face tracking.

Here, in the case in which the server device 400 includes the specifying portion 430, the server device 400 can generate display change information for changing the display mode of the character object, and send, to the user terminal of each of the users participating in the video chat, the display change information. Then, in the user terminals, the display mode of the character object related to one user can be changed based on the display change information.

Alternatively, if the user terminal is provided with the above-described specifying portion 430, the user terminal of one user can generate display change information to change the display mode of the character object, and send the display change information to the server device 400, and the server device 400 can send the display change information to the user terminals of other users participating in the video chat. Also, at the user terminal of the one user, based on the above-described display change information owned by the user terminal itself, the display mode of the character object related to the one user can be changed based on the display change information received from the server device 400.

If the receiver 410 is not receiving information related to sound from the user terminal, or if information related to sound received by the receiver 410 meets a second condition, the specifying portion 430 can specify that the user terminal is in a second state.

Examples of the case in which the receiver 410 is not receiving information related to sound from the user terminal include (i) a case in which the microphone is turned off, or (ii) a case in which the microphone is on, but the receiver 410 is not receiving information related to sound due to communication or other reasons, or the like.

In addition, an example of the case in which the information related to the sound received by the receiver 410 meets a second condition is a case in which the microphone at the user terminal is on and information related to sound is being received, but it is determined that the user has not said anything for a predetermined period of time, or the like.

The determination that the user has not said anything may be made by speech analysis, or may be determined by quantifying the sound. Also, the predetermined time here can be, for example, about five minutes, but is not limited to this, and may be set by the user.

When the specifying portion 430 specifies that the user terminal is in the second state, the controller 440 can attach a second specific object to the character object and/or apply a second specific movement to the character object, as a change in the display mode of the character object.

The second specific object can be an object to indicate a state in which the character object is not speaking.

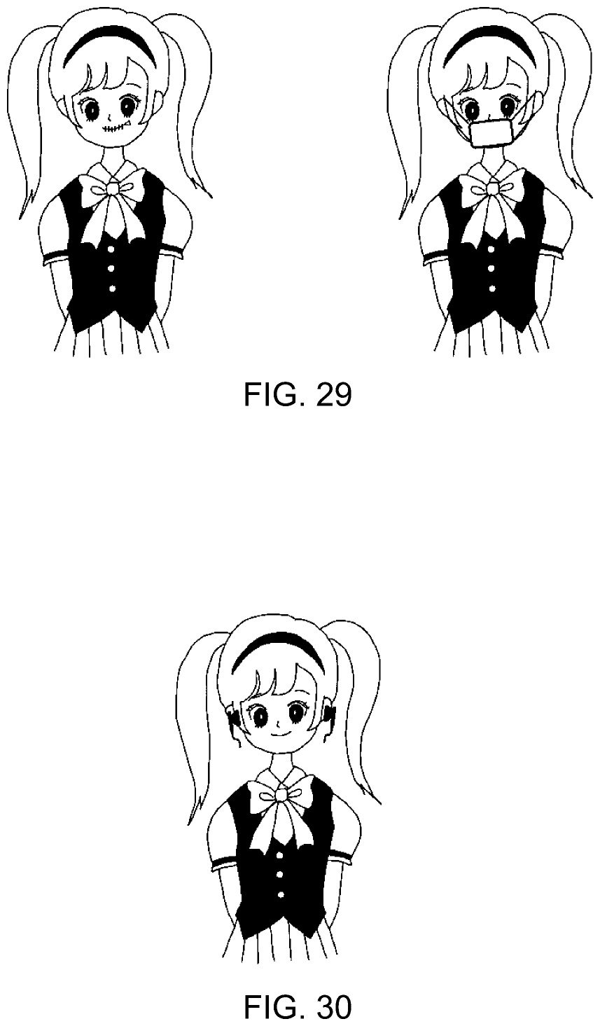

Objects used to indicate that the character object is not speaking include, as an example, objects that cover at least the character objects mouth, such as a mouth zipper object and a mask object as shown in FIG. 29.

These attached objects can be displayed in association with specific parts of the character object.

Such a specific part can be a part related to the state (here, the second state) of the user terminal, for example, a part (for example, mouth) related to the act of “speaking” when the character object is shown in a state of not speaking.

The second specific movement can be a movement to show that the character object is not speaking.

A movement to indicate that the character object is not speaking includes, for example, covering the mouth with the hand, and the like.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

In addition, according to the above-described configuration, there is also an advantage that it is possible to display a wide variety of avatars with low load compared to the case of displaying a character object that moves its mouth according to face tracking.

The specifying portion 430 can specify that the user terminal is in a third state when the receiver 410 receives information indicating that a specific application is being run or displayed at the user terminal.

A specific application running at the user terminal means that a specific application is running in the background or foreground at the user terminal, and a specific application being displayed at the user terminal means that the specific application is running in the foreground at the user terminal.

The specific application can be, for example, a music playback application, a video playback application, a game application, a telephone call application, or the like.

In a configuration in which the video is automatically switched off by starting or displaying the specific application, the third state is a state that can be included in the first state. However, in this example, the change of the display mode, which will be described below, is preferentially or additionally executed.

Similarly, in a configuration in which the microphone is automatically switched off by starting or displaying the above-described specific application, the third state is a state that can be included in the second state. However, in this example, the change in display mode described below is preferentially or additionally executed.

When the specifying portion 430 specifies that the user terminal is in the third state, the controller 440 may, as a change in the display mode of the character object, attach a third specific object to the character object and/or apply a third specific movement to the character object.

The third specific object can be, as an example, at least one of the following objects: (i) an object to indicate that, the character object is not looking at the video chat screen, (ii) an object to indicate that the character object is not speaking, and (iii) an object to indicate that the character object is not listening to the sound of the video chat.

The object to indicate that the character object is not looking at the video chat screen and the object to indicate that the character object is not speaking are described above.

Objects to indicate that the character is object not listening to the sound of the video chat include, as an example, objects that cover at least the character object's ears, such as the earphone objects shown in FIG. 30.

Such attached objects can be displayed in association with specific parts of the character object.

Such a specific part can be a part related to the state (here, the third state) of the user terminal, for example, a part (for example, an ear) related to the act of “listening” if a state is shown in which the character object is not listening to the sound of the video chat.

The third specific movement can be, as an example, at least one of the following movements: (i) a movement to indicate that the character object is not looking at the video chat screen. (ii) a movement to indicate that the character object is not speaking, and (iii) a movement to indicate that the character object is not listening to the sound of the video chat.

The movement to indicate that the character object is not looking at the video chat screen and the movement to indicate that the character object is not speaking are described above.

An example of a movement to indicate that the character object is not listening to the sound of the video chat includes a movement of covering the ears with hands.

In addition, the controller 440 may also change the display mode of the character object according to the type of a specific application that is started or displayed at the user terminal.

For example, if the specific application is a music playback application, the display mode is changed so that the character object is displayed as if it were listening to music.

Specifically, as the third object, the character object is caused to wear an earphone object or headphone object, or a musical note object is caused to be displayed near the character object. As the third movement, a rhythmic movement is caused to be applied to the character object in time with the music. These applications are not limited to one, and a plurality of objects and/or movements can be applied to the character object.

Alternatively, if the specific application is a video playback application, the display mode is changed so that the character object is displayed as if it were watching a video (movie or the like).

Specifically, as the third object, a popcorn object or a drink object is caused to be attached to the character object, or a screen object is caused to be displayed near the character object, and as the third movement, a movie watching movement is caused to be applied to the character object. These applications are not limited to one, and a plurality of objects and/or movements can be applied to the character object.

Alternatively, if the specific application is a game application, the display mode is changed so that the character object is displayed as if it were playing a game.

Specifically, as the third object, a controller object is caused to be attached to the character object, or a game machine object or a monitor object is caused to be displayed near the character object. As the third movement, a game playing movement is caused to be applied to the character object. These applications are not limited to one, and a plurality of objects and/or movements can be applied to the character object.

Alternatively, if the specific application is a telephone call application, the display mode is changed so that the character object is displayed as if it were making a call.

Specifically, as the third object, the character object is caused to wear a telephone handset object or smartphone object, or a telephone object is caused to be displayed near the character object. As the third movement, a movement to make a call is caused to be applied to the character object. These applications are not limited to one, and a plurality of objects and/or movements can be applied to the character object.

According to the above-described configurations, it is possible to more specifically display the user's situation so that other users can easily understand it.

If the volume of a sound other than the user's speaking included in the information related to the sound received by the receiver 410 is greater than or equal to a first value, the specifying portion 430 can specify that the user terminal is in a fourth state.

The other sound is, for example, speaking of another user(s), environmental sounds, or the like. Whether the speaking is made by the user or by another user can be identified by using a known speech recognition technology. Furthermore, environmental sounds include a TV sound, an intercom sound, a telephone ringing sound, animal noises, a sound of a train station announcement, sounds of trains, cars, motorcycles, and the like, sounds of multiple people talking, or the like.

The first value can be greater than or equal to the volume of the user's speaking.

At this time, the one or more computer processors in this disclosure can further include a sound determination portion. The sound determination portion determines (i) whether or not the information related to sound received by the receiving portion 410 includes another sound, and (ii) whether or not the volume of the sound other than the speaking by the user is greater than or equal to the first value. Also, the sound determination portion may analyze the type of the other sound.

Additionally, the fourth state is a state that can be included in the first state, the second state and the third state, but in this example, the change in the display mode described below can be preferentially or additionally applied.

When the specifying portion 430 specifies that the user terminal is in the fourth state, as the change in the display mode of the character object, the controller 440 can attach a fourth specified object to the character object and/or apply a fourth specific movement to the character object.

The fourth specific object can be an object to indicate that the character object finds it difficult to hear the sound of the video chat.

An object to indicate that the character object finds it difficult to hear the sound of the video chat includes, for example, an object that covers at least the ears of the character Object, such as an earplug object, or the like.

The fourth specific movement can be a movement to indicate that the character object finds it difficult to hear the sound of the video chat.

A movement to indicate that the character object finds it difficult to hear the sound of the video chat includes, for example, a movement that covers the ears of the character object with hands, or the like.

Also, the controller 440 may change the display mode of the character object according to the type of other sound analyzed by the sound determination portion. The change in the display mode at this time may be applied regardless of the volume of the other sound.

For example, if the other sound is noise at a train station, the display mode is changed so that the character object perceives the sound as being too loud, or as not being able to hear the sounds of the video chat.

Specifically, as the fourth object, a noise object is caused to be attached to the character object, or the noise object is caused to be displayed near the character object, and as the fourth movement, a movement is applied that causes the character object to cover its ears. These applications are not limited to one, but a plurality of objects and/or movements can be applied to the character object. Additionally, the noise object displayed here can also be determined according to the type analyzed from the other sound. For example, if the other sound is the sound of a television, the noise object can be a television object, and can be an object indicating the source of the sound that causes the noise.

Also, if the other sound is the sound of an interphone, the display mode is changed so that the character object is displayed as if it were going to pick up a package.

Specifically, as the fourth object, a package object is caused to be attached to the character object, or a package object is caused to display near the character object, and as the fourth movement, a movement of going to pick up package is caused to be applied to the character object. These applications are not limited to one, but a plurality of objects and/or movements can be applied to the character object.

Alternatively, if the other sound is a cry/barking of an animal (pet), the display mode is changed so that the character object is displayed as if it were caring for or feeding the pet.

Specifically, as the fourth object, a pet object is caused to be attached to the character object, or a pet object is caused to be displayed near the character object, and as the fourth movement, a petting or feeding movement is applied to the character object. These applications are not limited to one, but a plurality of objects and/or movements can be applied to the character object. The pet object and the object representing food displayed here can also be determined according to the type of animal analyzed from the cry/barking.

Alternatively, if the other sound is that of a child, the display mode is changed so that the character object is displayed as if it were caring for the child.

Specifically, as the fourth object, a child object is caused to be attached the character object, or a child object is caused to be displayed near the character object, and as the fourth movement, a movement to soothe a child is applied to the character object. These applications are not limited to one, but a plurality of objects and/or movements can be applied to the character object. Furthermore, the child object displayed here can be determined according to gender and/or age as analyzed from the voice.

According to the above-described configurations, it is possible to more specifically display the user's situation so that other users can easily understand it.

If the specifying portion 430 specifies that the user terminal is in the fourth state, the controller 440 can generate a video without including information related to the sound if the volume of the other sound is greater than or equal to a second value.

The second value is a value greater than the first value described above, and indicates the volume at which the user's voice is drowned out and not heard. Such a second value may be changed relative to the volume of the user's voice, or it may be a predetermined absolute value.

At this time, the sound determination portion described above further determines whether the volume of other sound other than the user's voice included in the information related to the sound received by the receiver 410 is greater than or equal to the first or second value.

Instead of not including information related to all sounds, it is also possible to generate a video without including only information related to other sounds. In this case, it can be realized by applying a known noise cancellation technology.

According to the above-described configuration, it is possible to make it easier to hear the user's voice in the video chat.

The specifying portion 430 can specify that the user terminal is in the fifth state when the receiver 410 does not receive information related to movement of the user from the user terminal, but receives information related to sound.

The fifth state is a state that can be included in the first state, but in this embodiment, the change in the display mode that will be described later can be preferentially or additionally applied.

Examples of a case in which the receiver 410 does not receive information related to movement of the user from the user terminal, but receives information related to sound, include (i) a case in which the user is speaking in a video chat with video off and microphone on, and (ii) a case in which the user is speaking in a video chat without moving, with video and microphone on.

When the specifying portion 430 specifies that the user terminal is in the fifth state, the controller 440 can apply a fifth movement to the character object as a change in the display mode of the character object.

The fifth movement can be to move the mouth of the character object according to the information related to sound.

The information related to movement of the user includes information related to the movement of the user's mouth; thus, the movement of the user's mouth is usually captured in the movement of the mouth of the character object. On the other hand, in this embodiment, the situation is that information related to the movement of the user is not obtained. Therefore, based on information related to the user's voice, the mouth of the character object is synchronized with the voice (lip-sync). A known technique can be applied for such a lip-sync technology.

At this time, the one or more computer processors in this disclosure may include a speech analyzer.

According to the above-described configuration, it is possible to appropriately control the movement of the mouth of the character object even when information related to the movement of the user is not acquired.

The receiver 410 can also receive position information of the user terminal that is sent from the user terminal. At this time, the specifying portion 430 specifies that the user terminal in in a sixth state when the position information satisfies a predetermined condition.

The predetermined condition related to the position information can be based on a moving speed that is calculated based on the position information. A predetermined condition can be satisfied by the position information when the moving speed is greater than or equal to a predetermined value. The predetermined value can be a speed at which a human is running, or the like, but is not limited to this.

Such a state is a state that can be included in the above first to fifth states, but in this embodiment, the change in the display mode that will be described later can be preferentially applied.

When the specifying portion 430 specifies that the user terminal is in the sixth state, as a change in the display mode of the character object, according to the moving speed based on the position information, the controller 440 can attach a sixth specific object to the character object and/or apply a sixth specific movement to the character object.

The sixth specific object can be an object to indicate that the character object is moving.

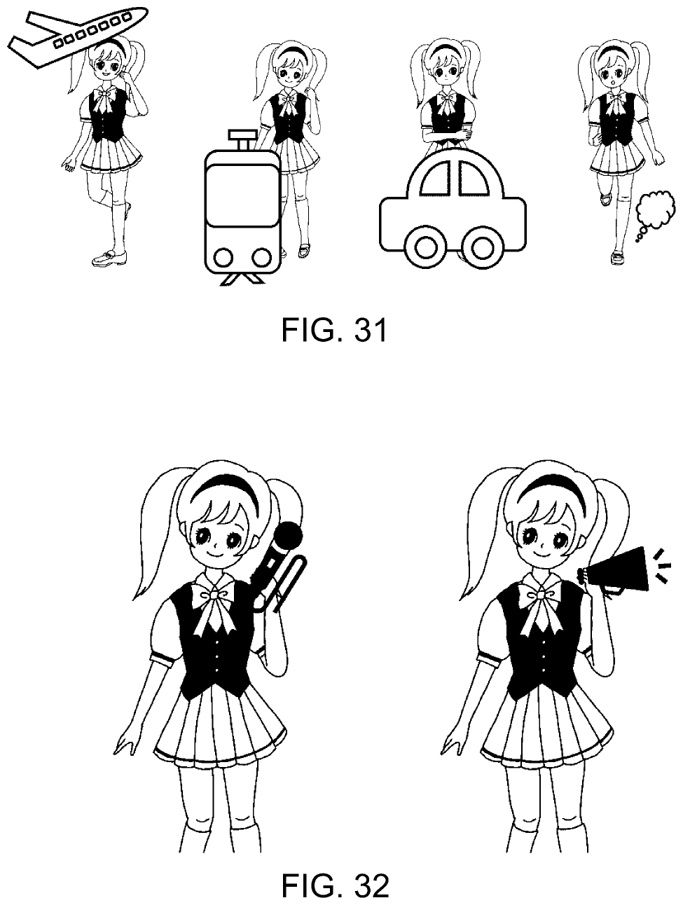

Objects to show that the character object is moving include, as examples, objects indicating that the character object is riding in a vehicle, such as an airplane object, a train object, and a car object as shown in FIG. 31.

These attached objects can be displayed in association with a specific part of the character object.

Such a specific part can be a part related to the state of the user terminal (here, the sixth state), for example, a part related to the act of “moving” (for example, legs or hips) to show that the character object is moving.

The sixth specific movement can be a movement to show the character object moving.

The movement to show the character object moving includes, as an example, a running movement such as that shown in FIG. 31.

According to the above-described configuration, it is possible to more specifically display the user's situation so that other users can easily understand it.

The receiver 410 can also receive instruction information that is sent from the user terminal. At this time, the controller 440 changes the display mode of the character object according to an instruction included in the instruction information.

Specifically, by user operation with respect to a video object VC12 and/or a microphone object VC11 displayed on the user terminal, the instruction information may be sent by selection of an instruction object additionally displayed when the camera function and/or the microphone function are turned off.

Such a state is a state that can be included in the first to sixth states described above, but in this embodiment, a change in display mode, which will be described later, can be preferentially applied.

The controller 440 can attach a seventh specific object to the character object and/or apply a seventh specific movement to the character object, as a change in the display mode of the character object.

The seventh specific object can be an object on which a predetermined text is displayed.

An example of an object on which a predetermined text is displayed includes a placard object, a billboard Object, and the like. The placard object may display characters or the like indicating the user's status. Examples of the user's status include, but are not limited to, characters such as “away from a desk,” “playing game,” “currently moving,” and the like.

The seventh specific movement can be a movement of moving at least part of the character object at predetermined intervals.

The movement of moving at least part of the character object at predetermined intervals includes, for example, movements of the character object blinking, nodding, laughing, and the like.

The attachment of the seventh specific object and/or the application of the seventh specific movement may be selected by the user's desire by operating the instruction object.

At this time, the seventh specific object can include all of the first object, second object, third object, fourth object, fifth object, and sixth object that are described above. The user can select a desired object from a plurality of instruction objects corresponding to each of these objects, and attach the desired object to the character object.

Similarly, the seventh specific movement can include all of the first specific movement, second specific movement, third specific movement, fourth specific movement, fifth specific movement, and sixth specific movement that are described above. The user can select a desired movement from a plurality of instruction objects corresponding to each of these movements, and apply it to the character object.

According to the above-described configuration, it is possible to more specifically display the user's situation so that other users can easily understand it.

The specifying portion 430 can specify that the user terminal is in an eighth state wh the volume of the user's voice included in the information related to sound received by the receiver 410 satisfies a predetermined condition.

At this time, the above-described sound determination portion determines whether the volume of the sound of the user's voice included in the information related to sound received by the receiver 410 is a value outside a predetermined range.

Here, a volume outside the predetermined range means a volume outside an appropriate range for the volume of the user's voice in the video chat. For example, a case in which the user's voice is too loud for a video chat or a case in which the user's voice is too quiet fall outside the above-mentioned appropriate range. Such a volume value may be defined by a specific numerical value, or may be relatively determined based on the volume of other users' voices and/or the volume of another sound other than the user's voice.

Furthermore, when the specifying portion 430 specifies that the user terminal is in an eighth state, the controller 440 can attach an eighth specific object to the character object and/or display the eighth specific object in the video, according to the volume of the voice.

The eighth specific object includes, for example, an object to indicate the volume of voice, or the like.

Objects to indicate the volume of the spoken voice include, but are not limited to, a microphone Object, a megaphone object (FIG. 32), a volume meter object, and the like.

The size of the microphone object and the megaphone object may be displayed so as to increase as the volume of the voice increases, and the volume meter object may change the meter according to the volume of the spoken voice.

Additionally, these attached objects may be displayed in association with a specific part (for example, mouth) of the character object, or may be displayed around the character object.

The eighth specific movement includes, for example, a movement to indicate the volume of the voice.

The movement to indicate the volume of the voice includes, specifically, a megaphone-like movement with the hand over the mouth, a movement of secret talk with the index finger over the mouth, and the like.

The above-described volume meter object may be displayed on the screen even when the user terminal is not in the eighth state.

According to the above-described configuration, the user's voice in a video chat can be displayed in a way that is easily understood by other users via the character Object.

Next, an information processing method according to an embodiment of this disclosure will be explained.

An information processing method according to an embodiment of this disclosure can be executed in the information processing system 3000 that includes one or more user terminals and the server device 400.

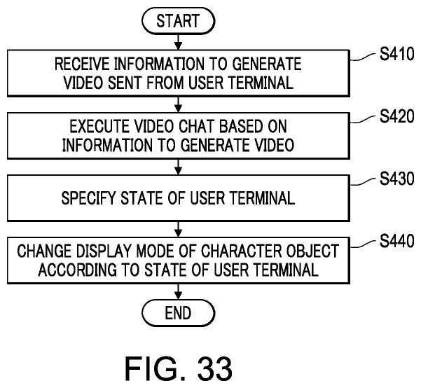

The information processing method according to this disclosure causes one or more computer processors included in the information processing system 3000 to execute a receiving step S410, an executing step S420, a specifying step S430, and a control step S440, as shown in FIG. 33 as an example.

In the receiving step S410, information for generating a video can be received. The information includes (i) information related to the movement of the user, (ii) information related to sound, and (iii) information related to the character object, which are sent from the user's user terminal. This receiving step S410 can be executed by the receiver 410 described above.

The receiving step S410 can be executed at the server side (server device 400).

In the executing step S420, a video chat between a plurality of users using character objects is executed based on the information for generating a video, received in the receiving step S410. This executing step S420 can be executed by the executing portion 420 described above.

The executing step S420 may be executed at the server side (server device 400) or may be executed at a client side (user terminal).

In the specifying step S430, the state of the user terminal is specified. The specifying step S430 may be executed by the specifying portion 430 described above.

The specifying step S430 may be executed at the server side (server device 400) or may be executed at the client side (user terminal).

In the control step S440, the display mode of the character object corresponding to the user terminal specified in the specifying step S430 is changed according to the state of the user terminal. This control step S440 can be executed by the controller 440 described above.

The control step S440 may be executed at the server side (server device 400) or may be executed at the client side (user terminal).

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

Next, a computer program according to an embodiment of this disclosure will be explained.

The computer program according to an embodiment of this disclosure can be executed in the information processing system 3000 that includes one or more user terminals and the server device 400.

The computer program according to this disclosure causes one or more computer processors included in the information processing system 3000 to implement a receiving function, an executing function, a specifying function, and a control function.

The receiving function can receive information for generating a video, including information related to the user's movement, information related to sound, and information related to a character object, that are sent from the user's user terminal.

The executing function executes a video chat between a plurality of users using character objects, based on the information for generating a video received by the receiving function.

The specifying function specifies the state of the user terminal.

The control function changes the display mode of the character object corresponding to the user terminal according to the state of the user terminal specified by the specifying function.

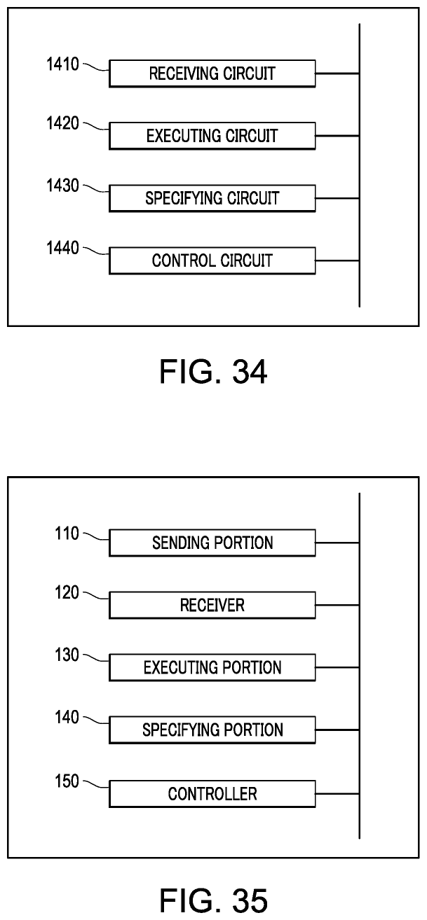

The above functions can be realized by a receiving circuit 1410, an executing circuit 1420, a specifying circuit 1430 and control circuit 1440 shown in FIG. 34. The receiving circuit 1410, the executing circuit 1420, the specifying circuit 1430, and the control circuit 1440 are realized by the receiver 410, the executing portion 420, the specifying portion 430, and the controller 440 described above, respectively. The details of each part are as described above.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

Next, an information processing device according to an embodiment of this disclosure will be explained. The information processing device corresponds to the user terminal in the information processing system 3000 described above.

The information processing device is an information processing device that includes one or more computer processors, and the one or more computer processors include, as shown in FIG. 35 a sending portion 110, a receiver 120, an executing portion 130, a specifying portion 140, and a controller 150.

The sending portion 110 can send, to the server device, information for generating a video related to the user, including information related to the user's movement, information related to sound, and information related to a character object(s). The information for generating a video is as described above.

The receiver 120 can receive, from the server device 400, information for generating a video related to another user(s) including information related to movements of the other user(s), information related to sound, and information related to a character object(s).

The executing portion 130 executes a video chat between a plurality of users using character objects based on the information for generating a video related to the user and the information for generating a video related to the other user(s). The executing portion 130 can have the same configuration as the executing portion 420 described above.

The specifying portion 140 specifies the state of the information processing device. The specifying portion 140 can have the same configuration as the specifying portion 430 described above.

The controller 150 changes the display mode of the character object corresponding to the user terminal according to the state of the user terminal specified by the specifying portion 140. The controller 150 can have the same configuration as the controller 440 described above.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

Next, an example of an information processing method according to an embodiment of this disclosure will be described. Such an information processing method is an information processing method executed in the information processing device (user terminal) described above.

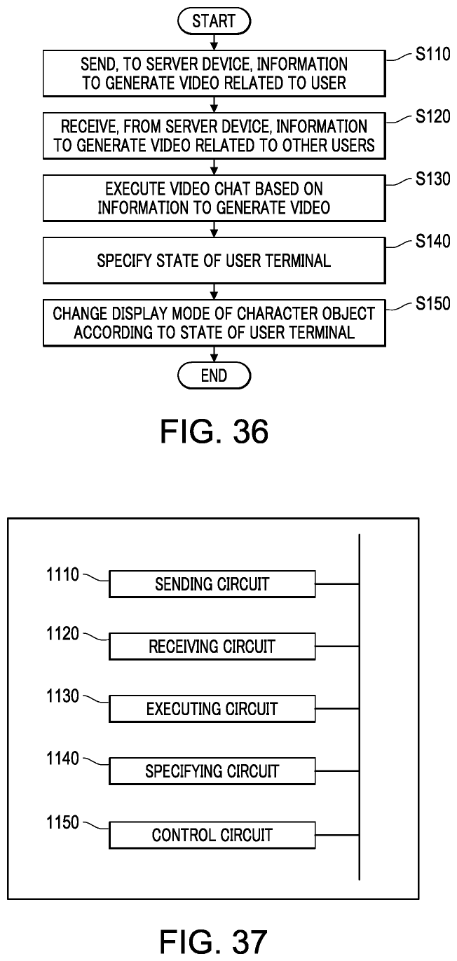

As shown in FIG. 36 as an example, the information processing method according to this disclosure causes one or more computer processors included in the information processing device to execute a sending step S110, a receiving step S120, an executing step S130, a specifying step S140, and a control step S150.

In the sending step S110, information for generating a video related to the user, including information related to the user's movement, information related to sound, and information related to a character object, can be sent to the server device. This sending step S110 can be executed by the sending portion 110 described above.

In the receiving step S120, information for generating a video related to another user(s), including information related to movement of the other user(s), information related to sound, and information related to a character object(s), can be received from the server device. This receiving step S120 can be executed by the receiver 120 described above.

In the executing step S130, a video chat between a plurality of users using character objects is executed based on the information for generating a video of the user and the information for generating a video of the other user(s). This executing step S130 can be executed by the executing portion 130 described above.

In the specifying step S140, the state of the information processing device is specified. This specifying step S140 can be executed by the specifying portion 140 described above.

In the control step S150, the display mode of the character object corresponding to the user terminal is changed according to the state of the user terminal specified in the specifying step. This control step S150 can be executed by the controller 150 described above.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

Finally, a computer program according to an embodiment of this disclosure will be described. Such a computer program is a computer program executed in the information processing device (user terminal TOO) described above.

The computer program according to this disclosure causes one or more processors included in an information processing device to realize a sending function, a receiving function, an executing function, a specifying function, and a control function.

The sending function can send, to a server device, information for generating a video related to a user, including information related to the user's movement, information related to sound, and information related to a character object.

The receiving function can receive, from the server device, information for generating a video related to another user(s), including information related to movement of the other user(s), information related to sound, and information related to a character object(s).

The executing function executes a video chat between a plurality of users using character objects based on the information for generating a video related to the user and the information for generating a video related to the other user(s).

The specifying function specifies the state of the information processing device.

The control function changes the display mode of the character object corresponding to the user terminal according to the state of the user terminal specified by the specifying function.

The above-described functions can be realized by a sending circuit 1110, a receiving circuit 1120, an executing circuit 1130, a specifying circuit 1140, and a control circuit 1150 shown in FIG. 37. The sending circuit 1110, the receiving circuit 1120, the executing circuit 1130, the specifying circuit 1140, and the control circuit 1150 are realized by the sending portion 110, the receiver 120, the executing portion 130, the specifying portion 140, and the controller 150 described above, respectively. The details of each part are as described above.

The above-described configuration provides a technical improvement that solves or alleviates at least some of the problems of the conventional technology described above. Specifically, it is possible to suppress miscommunication and activate communication between users by displaying the status of a user in a video chat in a manner that is easily understood by other users via a character object.

Furthermore, an information processing device such as a computer or a mobile phone can be preferably used to function as the server device or the terminal device according to the above-described embodiments. Such an information processing device can be realized by (i) storing a program, which describes the processing content for realizing each function of the server device or the terminal device related to the embodiments, in a storage portion of the information processing device, and (ii) reading and executing the program by a CPU of the information processing device.

While several embodiments have been described, these embodiments have been presented by way of example and are not intended to limit the scope of the disclosure. These novel embodiments can be implemented in various other forms. Also, various omissions, substitutions, and modifications can be made without departing from the scope of the disclosure. These embodiments and their modifications are included in the scope and summary of the disclosure, and are included in the scope described in the claims, and equivalents thereof.

Additionally, the methods described in the embodiments can be stored in a recording medium, for example, a magnetic disk (a floppy (registered trademark) disk, a hard disk, or the like), an optical disk (CD-ROM, DVD, MO, or the like), a semiconductor memory (ROM, RAM, flash memory, or the like), or the like, as programs that can be executed by a calculator (computer), and can also be sent and distributed via a communication medium. The program(s) stored at the medium side also includes a setting program that causes software means (including not only the executing program, but also a table(s) and data structure(s)) executed by the calculator to be constituted in the calculator. A calculator that realizes this device reads the program(s) recorded on the recording medium, and in some cases, builds software means by the setting program, and executes the above-described processing by controlling the operation by this software means. The term “recording medium” as used in this specification includes not only those for distribution, hut also storage media such as a magnetic disk and a semiconductor memory provided inside calculators or devices connected via a network. The storage portion may function, for example, as a main storage device, an auxiliary storage device, or a cache memory.

### EXPLANATION OF SYMBOLS

100 distributing user terminal
200 viewing user terminals
300 network
400 server device
410 receiver
420 executing portion
430 specifying portion
440 controller

1. An information processing system comprising:
one or more processors programmed to:
receive information for generating a video, including information related to movement of a user, information related to sound, and information related to a character object, that is sent from a user terminal of a user;
execute a video chat between a plurality of users using character objects, based on the received information for generating the video;
specify a state of the user terminal; and
change a display of the character object corresponding to the user terminal according to the specified state of the user terminal.

2. The information processing system according to claim 1, wherein
when the one or more processors have not received the information related to the movement of the user from the user terminal, or when the received information related to the movement of the user satisfies a first condition, the one or more processors specify that the user terminal is in a first state.

3. The information processing system according to claim 2, wherein
the first condition is that the one or more processors continue to receive information related to a same movement for a predetermined period of time, or do not receive, for a predetermined period of time, information related to an amount of change in movement that is sent only when the movement changes.

4. The information processing system according to claim 2, wherein
when the one or more processors specify that the user terminal is in the first state, as a change in the display of the character object, the one or more processors attach a first specific object to the character object and/or apply a first specific movement to the character object.

5. The information processing system according to claim 4, wherein
the first specific object is an object to indicate that the character object is not looking screen of the video chat, and the first specific movement is a movement to indicate that the character object is not looking at the screen of the video chat.

6. The information processing system according to claim 1, wherein
when the one or more processors have not received the information related to the sound from the user terminal, or when the received information related to the sound satisfies a second condition, the one or more processors specify that the user terminal is in a second state.

7. The information processing system according to claim 6, wherein
when the one or more processors specify that the user terminal is in the second state, as a change in the display of the character object, the one or more processors attach a second specific object to the character object and/or apply a second specific movement to the character object.

8. The information processing system according to claim 7, wherein
the second specific object is an object to indicate that the character object is not speaking, and
the second specific movement is a movement to indicate that the character object is not speaking.

9. The information processing system according to claim 1, wherein
when the one or more processors receive information indicating that a specific application is running or being displayed at the user terminal, the one or more processors specify that the user terminal is in a third state.

10. The information processing system according to claim 9, wherein
when the one or more processors receive information indicating that a music playback application is running at the user terminal, the one or more processors specify that the user terminal is in the third state.

11. The information processing system according to claim 10, wherein
when the one or more processors specify that the user terminal is in the third state, as a change in the display of the character object, the one or more processors attach a third specific object to the character object and/or apply a third specific movement to the character object.

12. The information processing system according to claim 11, wherein
the third specific object is an object to indicate that the character object is listening to music, and
the third specific movement is a movement to indicate that the character object is listening to music.

13. The information processing system according to claim 1, wherein
when a volume of a sound other than speaking by the user included in the received information related to the sound is greater than or equal to a first value, the one or more processors specify that the user terminal is in a fourth state.

14. The information processing system according to claim 13, wherein
when the one or more processors specify that the user terminal is in the fourth state, as a change in the display of the character object, the one or more processors attach a fourth specific object to the character object and/or apply a fourth specific movement to the character object.

15. The information processing system according to claim 14, wherein
the fourth specific object is an object to indicate that the character object feels that sound of the video chat is difficult to hear, and
the fourth specific movement is a movement to indicate that the character object feels that the sound of the video chat is difficult to hear.

16. The information processing system according to any of claim 13, wherein
when the one or more processors specify that the user terminal is in the fourth state, the one or more processors generate the video without including information related to the sound when the volume of the other sound is greater than or equal to a second value.

17. An information processing method by one or more processors, the method comprising:
receiving information for generating a video, including information related to movement of a user, information related to sound, and information related to a character object, that is sent from a user terminal of the user;
executing a video chat between a plurality of users using character objects, based on the received information for generating the video;
specifying a state of the user terminal; and
changing a display of the character object corresponding to the user terminal according to the specified state of the user terminal.

18. An information processing device comprising:
one or more processors programmed to:
send, to a server device, information for generating a video related to a user, including information related to movement of the user, information related to first sound, and information related to a first character object;
receive, from the server device, information for generating a video related to another user, including information related to movement of the other user, information related to second sound, and information related to a second character object;
execute a video chat between a plurality of users using character objects, based on the information for generating the video related to the user and the information for generating the video related to the other user;
specify a state of the information processing device; and
change a display of the first character object corresponding to the information processing device according to the specified state of the information processing device.
